(19) United States
(12) Patent Application Publication
(10) Pub. No.: US 2021/0122952 A1
(43) Pub. Date: Apr. 29, 2021

(54) CURABLE COMPOSITIONS, ARTICLES THEREFROM, AND METHODS OF MAKING AND USING SAME

(71) Applicant: 3M INNOVATIVE PROPERTIES COMPANY, St. Paul, MN (US)

(72) Inventors: Li Yao, Woodbury, MN (US); Rajdeep S. Kalgutkar, Woodbury, MN (US); Mario A. Perez, Burnsville, MN (US); Wayne S. Mahoney, St. Paul, MN (US); Jeremy M. Higgins, Roseville, MN (US); Brett A. Beierman, St. Paul, MN (US)

(21) Appl. No.: 15/733,482

(22) PCT Filed: Jan. 31, 2019
(86) PCT No.: PCT/IB2019/050789

§ 371 Date: Aug. 7, 2020

Related U.S. Application Data
(60) Provisional application No. 62/629,347, filed on Feb. 12, 2018.

(51) Int. Cl. C09J 135/02; C09J 177/06; C09J 11/04; C09K 5/14; H01M 10/6551; H01M 10/625

(52) U.S. Cl. CPC C09J 135/02; C09J 177/06; C09J 11/04; H01M 2220/20; H01M 10/6551; H01M 10/625; C09K 5/14

(57) ABSTRACT

A curable composition includes a polyamide composition that includes a first polyamide. The first polyamide includes a tertiary amide in the backbone thereof and is amine terminated. The curable composition further includes an amino functional compound comprising from 2 to 20 carbon atoms, a multifunctional (meth)acrylate, an epoxy resin, and an inorganic filler. The inorganic filler is present an amount of at least 25 wt. %, based on the total weight of the curable composition.

### FIELD

The present invention generally relates to curable compositions. The curable compositions may be used, for example, as thermally conductive gap fillers, which may be suitable for use in electronic applications such as battery assemblies.

### BACKGROUND

Curable compositions based on epoxy or polyamide resins have been disclosed in the art. Such curable compositions are described in, for example, U.S. Pat. Nos. 2,705,223 and 6,008,313.

### SUMMARY

In some embodiments, a curable composition is provided. The curable composition includes a polyamide composition that includes a first polyamide. The first polyamide includes a tertiary amide in the backbone thereof and is amine terminated. The curable composition further includes an amino functional compound comprising from 2 to 20 carbon atoms, a multifunctional (meth)acrylate, an epoxy resin, and an inorganic filler. The inorganic filler is present an amount of at least 25 wt. %, based on the total weight of the curable composition.

It should be understood that numerous other modifications and embodiments can be devised by those skilled in the art, which fall within the scope and spirit of the principles of the disclosure. All scientific and technical terms used herein have meanings commonly used in the art unless otherwise specified. The definitions provided herein are to facilitate understanding of certain terms used frequently herein and are not meant to limit the scope of the present disclosure. As used in this specification and the appended claims, the singular forms “a”, “an”, and “the” encompass embodiments having plural referents, unless the context clearly dictates otherwise. As used in this specification and the appended claims, the term “or” is generally employed in its sense including “and/or” unless the context clearly dictates otherwise.

### BRIEF DESCRIPTION OF THE DRAWINGS

FIG. 1 illustrates the assembly of an exemplary battery module according to some embodiments of the present disclosure.

FIG. 2 illustrates the assembled battery module corresponding to FIG. 1.

FIG. 3 illustrates the assembly of an exemplary battery subunit according to some embodiments of the present disclosure.

### DETAILED DESCRIPTION

Thermal management plays an important role in many electronics applications such as, for example, electric vehicle (EV) battery assembly, power electronics, electronic packaging, LED, solar cells, electric grid, and the like. Certain thermally conductive materials (e.g., adhesives) may be an attractive option for these applications due to good electrical insulative properties, feasibility in processing for integrated parts or complex geometries, and good conformability/wettability to different surfaces, especially the ability to efficiently dissipate the heat away while having good adhesion to different substrates for assembly.

Regarding applications in EV battery assemblies, currently, one such application that utilizes a thermally conductive material is the gap filler application. Generally, requirements for the gap filler application include high thermally conductivity, good overlap shear adhesion strength, good tensile strength, good elongation at break for toughness, and good damping performance, in addition to having low viscosity before curing. However, to achieve high thermal conductivity, typically, a large amount of inorganic thermally conductive filler is added to the composition. The high loading of thermally conductive fillers, however, has a deleterious impact on adhesion performance, toughness, damping performance, and viscosity. Furthermore, compositions useful for the gap filler application should have relatively fast curing profiles to accommodate the automated processing requirements of the industry. For example, thermally conductive materials that attain adequate green strength after room temperature cure of about 10 minutes or less may be particularly advantageous.

Many current compositions employed in the EV thermal adhesive gap filler application are based on polyurethane curing chemistries. While these polyurethane based materials can exhibit properties that render them suitable as gap filler materials, the isocyanates used in such products pose safety concerns as well as poor stability at elevated temperatures.

In order to solve the above-discussed problems associated with high loadings of inorganic thermally conductive filler and the safety concerns associated with polyurethane based compositions, a curable composition providing a good balance of the desired properties has been discovered that includes a filled composition having an epoxy resin, a polyamide composition, an amino functional compound, and a multi-functional (meth)acrylate. The polyamides of this curable composition may be branched, amorphous, and promote hydrogen bonding which can enhance adhesion in the presence of high filler loading. The unique combination of polyamides of the present disclosure has advantages over polyurethane for these applications at least because (i) they are isocyanate-free compositions that do not interfere with environmental regulations, (ii) they provide better compatibility with various thermally conductive fillers, and (iii) they provide superior adhesion to aluminum and steel substrates. The curable compositions of the present disclosure also attain adequate green strength after room temperature cure of about 10 minutes or less.

As used herein:

The term “room temperature” refers to a temperature of 22° C. to 25° C.

The terms “cure” and “curable” refer to joining polymer chains together by covalent chemical bonds, usually via crosslinking molecules or groups, to form a network polymer. Therefore, in this disclosure the terms “cured” and “crosslinked” may be used interchangeably. A cured or crosslinked polymer is generally characterized by insolubility, but may be swellable in the presence of an appropriate solvent.

The term “backbone” refers to the main continuous chain of a polymer.

The term “aliphatic” refers to C1-C40, suitably C1-C30, straight or branched chain alkenyl, alkyl, or alkynyl which may or may not be interrupted or substituted by one or more heteroatoms such as O, N, or S.

The term “cycloaliphatic” refers to cyclized aliphatic C3-C30, suitably C3-C20, groups and includes those interrupted by one or more heteroatoms such as O, N, or S.

The term “alkyl” refers to a monovalent group that is a radical of an alkane and includes straight-chain, branched, cyclic, and bicyclic alkyl groups, and combinations thereof, including both unsubstituted and substituted alkyl groups. Unless otherwise indicated, the alkyl groups typically contain from 1 to 30 carbon atoms. In some embodiments, the alkyl groups contain 1 to 20 carbon atoms, 1 to 10 carbon atoms, 1 to 6 carbon atoms, 1 to 4 carbon atoms, or 1 to 3 carbon atoms. Examples of “alkyl” groups include, but are not limited to, methyl, ethyl, n-propyl, n-butyl, n-pentyl, isobutyl, t-butyl, isopropyl, n-octyl, n-heptyl, ethylhexyl, cyclopentyl, cyclohexyl, cycloheptyl, adamantyl, norbornyl, and the like.

The term “alkylene” refers to a divalent group that is a radical of an alkane and includes groups that are linear, branched, cyclic, bicyclic, or a combination thereof. Unless otherwise indicated, the alkylene group typically has 1 to 30 carbon atoms. In some embodiments, the alkylene group has 1 to 20 carbon atoms, 1 to 10 carbon atoms, 1 to 6 carbon atoms, or 1 to 4 carbon atoms. Examples of “alkylene” groups include methylene, ethylene, 1,3-propylene, 1,2-propylene, 1,4-butylene, 1,4-cyclohexylene, and 1,4-cyclohexyldimethylene.

The term “aromatic” refers to C3-C40, suitably C3-C30, aromatic groups including both carbocyclic aromatic groups as well as heterocyclic aromatic groups containing one or more of the heteroatoms, O, N, or S, and fused ring systems containing one or more of these aromatic groups fused together.

The term “aryl” refers to a monovalent group that is aromatic and, optionally, carbocyclic. The aryl has at least one aromatic ring. Any additional rings can be unsaturated, partially saturated, saturated, or aromatic. Optionally, the aromatic ring can have one or more additional carbocyclic rings that are fused to the aromatic ring. Unless otherwise indicated, the aryl groups typically contain from 6 to 30 carbon atoms. In some embodiments, the aryl groups contain 6 to 20, 6 to 18, 6 to 16, 6 to 12, or 6 to 10 carbon atoms. Examples of an aryl group include phenyl, naphthyl, biphenyl, phenanthryl, and anthracyl.

The term “arylene” refers to a divalent group that is aromatic and, optionally, carbocyclic. The arylene has at least one aromatic ring. Optionally, the aromatic ring can have one or more additional carbocyclic rings that are fused to the aromatic ring. Any additional rings can be unsaturated, partially saturated, or saturated. Unless otherwise specified, arylene groups often have 6 to 20 carbon atoms, 6 to 18 carbon atoms, 6 to 16 carbon atoms, 6 to 12 carbon atoms, or 6 to 10 carbon atoms.

The term “aralkyl” refers to a monovalent group that is an alkyl group substituted with an aryl group (e.g., as in a benzyl group). The term “alkaryl” refers to a monovalent group that is an aryl substituted with an alkyl group (e.g., as in a tolyl group). Unless otherwise indicated, for both groups, the alkyl portion often has 1 to 10 carbon atoms, 1 to 6 carbon atoms, or 1 to 4 carbon atoms and an aryl portion often has 6 to 20 carbon atoms, 6 to 18 carbon atoms, 6 to 16 carbon atoms, 6 to 12 carbon atoms, or 6 to 10 carbon atoms.

The term (meth)acrylate means acrylate or methacrylate.

Repeated use of reference characters in the specification is intended to represent the same or analogous features or elements of the disclosure. As used herein, the word “between”, as applied to numerical ranges, includes the endpoints of the ranges, unless otherwise specified. The recitation of numerical ranges by endpoints includes all numbers within that range (e.g. 1 to 5 includes 1, 1.5, 2, 2.75, 3, 3.80, 4, and 5) and any range within that range.

In some embodiments, the present disclosure provides a filler loaded thermally conductive curable composition, formulated by blending a polyamide composition, an epoxy resin, an amino functional compound, and a multi-functional (meth)acrylate. The composition provides exceptional tensile strength, elongation at break, and overlap shear strength, as well as exceptional adhesion to bare aluminum and steel substrates. In some embodiments, the polyamides of the present disclosure may contain tertiary amides in the backbone, which may enhance elongation at break at room temperature by reducing the volume density of hydrogen bonding and crosslinking and providing chain flexibility, while maintaining good adhesion to metallic substrates. In some embodiments, to reduce viscosity when high filler loadings are used, the structure and molecular weight of the polyamides may also be adjusted. Polyamide-compatible dispersants may also be added to further reduce compound viscosity.

In some embodiments, the curable compositions of the present disclosure may include an epoxy composition and a polyamide composition, the polyamide composition including one or more polyamides having one or more tertiary amides in the backbone thereof. The curable compositions may further include an amino functional compound and a multi-functional acrylate.

In some embodiments, the epoxy compositions may include one or more epoxy resins. Suitable epoxy resins epoxies may include aromatic polyepoxide resins (e.g., a chain-extended diepoxide or novolac epoxy resin having at least two epoxide groups), aromatic monomeric diepoxides, aromatic monomeric monoepoxides, aliphatic polyepoxide, or monomeric diepoxides. A crosslinkable epoxy resin typically will have at least two epoxy end groups. The aromatic polyepoxide or aromatic monomeric diepoxide typically contains at least one (in some embodiments, at least 2, in some embodiments, in a range from 1 to 4) aromatic ring that is optionally substituted by a halogen (e.g., fluoro, chloro, bromo, iodo), alkyl having 1 to 4 carbon atoms (e.g., methyl or ethyl), or hydroxyalkyl having 1 to 4 carbon atoms (e.g., hydroxymethyl). For epoxy resins containing two or more aromatic rings, the rings may be connected, for example, by a branched or straight-chain alkylene group having 1 to 4 carbon atoms that may optionally be substituted by halogen (e.g., fluoro, chloro, bromo, iodo).

In some embodiments, examples of aromatic epoxy resins useful in the epoxy compositions disclosed herein may include novolac epoxy resins (e.g., phenol novolacs, ortho-, meta-, or para-cresol novolacs or combinations thereof), bisphenol epoxy resins (e.g., bisphenol A, bisphenol F, halogenated bisphenol epoxies, and combinations thereof), resorcinol epoxy resins, tetrakis phenylolethane epoxy resins and combinations of any of these. Useful epoxy compounds include diglycidyl ethers of difunctional phenolic compounds (e.g., p,p′-dihydroxydibenzyl, p,p′-dihydroxydiphenyl, p,p′-dihydroxyphenyl sulfone, p,p′-dihydroxybenzophenone, 2,2′-dihydroxy-1,1-dinaphthylmethane, and the 2,2′, 2,3′, 2,4′, 3,3′, 3,4′, and 4,4′ isomers of dihydroxydiphenylmethane, dihydroxydiphenyldimethylmethane, dihydroxydiphenylethylmethylmethane, dihydroxydiphenylmethylpropylmethane, dihydroxydiphenylethylphenylmethane, dihydroxydiphenylpropylphenylmethane, dihydroxydiphenylbutylphenylmethane, dihydroxydiphenyltolylethane, dihydroxydiphenyltolylmethylmethane, dihydroxydiphenyldicyclohexylmethane, and dihydroxydiphenylcyclohexane.) In some embodiments, the adhesive includes a bisphenol diglycidyl ether, wherein the bisphenol (i.e., —O—C₆H₅—CH₂—C₆H₅—O—) may be unsubstituted (e.g., bisphenol F), or either of the phenyl rings or the methylene group may be substituted by one or more halogens (e.g., fluoro, chloro, bromo, iodo), methyl groups, trifluoromethyl groups, or hydroxymethyl groups.

In some embodiments, examples of aromatic monomeric diepoxides useful in the epoxy compositions according to the present disclosure include the diglycidyl ethers of bisphenol A and bisphenol F and mixtures thereof. Bisphenol epoxy resins, for example, may be chain extended to have any desirable epoxy equivalent weight. Chain extending epoxy resins can be carried out by reacting a monomeric diepoxide, for example, with a bisphenol in the presence of a catalyst to make a linear polymer.

In some embodiments, the aromatic epoxy resin (e.g., either a bisphenol epoxy resin or a novolac epoxy resin) may have an epoxy equivalent weight of at least 150, 170, 200, or 225 grams per equivalent. In some embodiments, the aromatic epoxy resin may have an epoxy equivalent weight of up to 2000, 1500, or 1000 grams per equivalent. In some embodiments, the aromatic epoxy resin may have an epoxy equivalent weight in a range from 150 to 2000, 150 to 1000, or 170 to 900 grams per equivalent. In some embodiments, the first epoxy resin has an epoxy equivalent weight in a range from 150 to 450, 150 to 350, or 150 to 300 grams per equivalent. Epoxy equivalent weights may be selected, for example, so that the epoxy resin may be used as a liquid or solid, as desired.

In some embodiments, in addition or as an alternative to aromatic epoxy resins, the epoxy resins of the present disclosure may include one or more non-aromatic epoxy resins. In some cases, non-aromatic epoxy resins can be useful as reactive diluents that may help control the flow characteristics of the compositions. Non-aromatic epoxy resins useful in the curable compositions according to the present disclosure can include a branched or straight-chain alkylene group having 1 to 20 carbon atoms optionally interrupted with at least one —O— and optionally substituted by hydroxyl. In some embodiments, the non-aromatic epoxy can include a poly(oxyalkylene) group having a plurality (x) of oxyalkylene groups, OR¹, wherein each R¹ is independently C₂ to C₅ alkylene, in some embodiments, C₂ to C₃ alkylene, x is 2 to about 6, 2 to 5, 2 to 4, or 2 to 3. To become crosslinked into a network, useful non-aromatic epoxy resins will typically have at least two epoxy end groups. Examples of useful non-aromatic epoxy resins include glycidyl epoxy resins such as those based on diglycidyl ether compounds comprising one or more oxyalkylene units. Examples of these include resins made from ethylene glycol diglycidyl ether, propylene glycol diglycidyl ether, diethylene glycol diglycidyl ether, dipropylene glycol diglycidyl ether, polyethylene glycol diglycidyl ether, polypropylene glycol diglycidyl ether, glycerol diglycidyl ether, glycerol triglycidyl ether, propanediol diglycidyl ether, butanediol diglycidyl ether, and hexanediol diglycidyl ether. Other useful non-aromatic epoxy resins include a diglycidyl ether of cyclohexane dimethanol, a diglycidyl ether of neopentyl glycol, a triglycidyl ether of trimethylolpropane, and a diglycidyl ether of 1,4-butanediol.

Crosslinked aromatic epoxies (that is, epoxy polymers) as described herein can be understood to be preparable by crosslinking aromatic epoxy resins. The crosslinked aromatic epoxy typically contains a repeating unit with at least one (in some embodiments, at least 2, in some embodiments, in a range from 1 to 4) aromatic ring (e.g., phenyl group) that is optionally substituted by one or more halogens (e.g., fluoro, chloro, bromo, iodo), alkyl groups having 1 to 4 carbon atoms (e.g., methyl or ethyl), or hydroxyalkyl groups having 1 to 4 carbon atoms (e.g., hydroxymethyl). For repeating units containing two or more aromatic rings, the rings may be connected, for example, by a branched or straight-chain alkylene group having 1 to 4 carbon atoms that may optionally be substituted by halogen (e.g., fluoro, chloro, bromo, iodo).

In some embodiments, the epoxy resins of the present disclosure may be liquid at room temperature. Several curable epoxy resins useful in the epoxy compositions according to the present disclosure may be commercially available. For example, several epoxy resins of various classes and epoxy equivalent weights are available from Dow Chemical Company, Midland, Mich.; Hexion, Inc., Columbus, Ohio; Huntsman Advanced Materials, The Woodlands, Tex.; CVC Specialty Chemicals Inc., Akron, Ohio (acquired by Emerald Performance Materials); and Nan Ya Plastics Corporation, Taipei City, Taiwan. Examples of commercially available glycidyl ethers include diglycidylethers of bisphenol A (e.g. those available under the trade designations “EPON 828”, “EPON 1001”, “EPON 1310” and “EPON 1510” from Hexion Inc. Columbus, Ohio, those available under the trade designation “D.E.R.” from Dow Chemical Co. (e.g., D.E.R. 331, 332, and 334), those available under the trade designation “EPICLON” from Dainippon Ink and Chemicals, Inc. (e.g., EPICLON 840 and 850) and those available under the trade designation “YL-980” from Japan Epoxy Resins Co., Ltd.); diglycidyl ethers of bisphenol F (e.g. those available under the trade designation “EPICLON” from Dainippon Ink and Chemicals, Inc. (e.g., “EPICLON 830”)); polyglycidyl ethers of novolac resins (e.g., novolac epoxy resins, such as those available under the trade designation “D.E.N.” from Dow Chemical Co. (e.g., D.E.N. 425, 431, and 438)); and flame retardant epoxy resins (e.g., “D.E.R. 580”, a brominated bisphenol type epoxy resin available from Dow Chemical Co.). Examples of commercially available non-aromatic epoxy resins include the glycidyl ether of cyclohexane dimethanol, available from Hexion Inc., Columbus Ohio, under the trade designation “HELOXY MODIFIER 107”.

In some embodiments, the epoxy compositions of the present disclosure may include epoxy resin in an amount of between 5 wt. % and 40 wt. %, 10 wt. % and 30 wt. %, 15 wt. % and 30 wt. %, or 20 wt. % and 30 wt. % (or may be even higher (up to 95%, 99%, or 100%) for epoxy compositions compositions that do not include fillers), based on the total weight of the epoxy composition (including any filllers). In some embodiments, the epoxy compositions of the present disclosure may include epoxy resin in an amount of at least 10 wt. %, at least 20 wt. %, at least 30 wt. %, at least 40 wt. %, or at least 50 wt. %, based on the total weight of the epoxy composition.

In some embodiments, the polyamide composition may include a first polyamide component and optionally a second polyamide component.

In some embodiments, the first polyamide component may include one or more polyamides that include one or more tertiary amides in the backbone thereof. In some embodiments, the tertiary polyamides may be present in the backbone of the polyamides in an amount of 50-100 mol %, 70-100 mol %, 90-100 mol %, 50-99 mol %, 70-99 mol %, 90-99 mol %, 95-100 mol %, or 95-99 mol %, or 99-100 mol %, based on the total amide content present in the polyamide backbone. In some embodiments, the tertiary polyamides may be present in the backbone of the polyamides in an amount of at least 50 mol %, at least 70 mol %, at least 90 mol %, at least 95 mol %, or at least 99 mol %, based on the total amide content present in the polyamide backbone. Generally, it is believed that the presence of such tertiary amides enhances elongation at break at room temperature by reducing the volume density of hydrogen bonding and crosslinking, while maintaining good adhesion to metallic substrates.

The polyamides of the first polyamide component may, in addition to the tertiary amides, include secondary amides in the backbone thereof. The polyamides of the first polyamide component may be amine terminated, including primary and secondary amine terminated.

In some embodiments, the polyamides of the first polyamide component may be liquid (e.g., a viscous liquid having a viscosity of about 500-50,000 cP) at room temperature.

In some embodiments, the polyamides of the first polyamide component may include the reaction product (e.g., by condensation polymerization) of a diacid component and a diamine component.

In some embodiments, the diacid component may include any long chain diacid (e.g., diacids that include greater than 15 carbon atoms). The diacid component may further include a short chain diacid (e.g., diacids that include between 2 and 15 carbon atoms). In some embodiments, the long chain diacid may be present in the diacid component in an amount of between 80-100 mol %, 85-100 mol %, 90-100 mol %, 95-100 mol %, 80-99 mol. %, or 80-95 mol. %; or at least 80 mol. %, at least 90 mol. %, or at least 95 mol. %, based on the total moles of the diacid component. In some embodiments, the short chain diacid may not be present in the diacid component, or may be present in the diacid component in an amount of between 1-20 mol %, 1-15 mol %, 1-10 mol %, or 1-5 mol. %, based on the total moles of the diacid component.

In some embodiments, the diacid component may include a dicarboxylic acid (e.g., in the form of a dicarboxylic dimer acid). In some embodiments, the dicarboxylic acid may include at least one alkyl or alkenyl group and may contain 3 to 30 carbon atoms and may be characterized by having two carboxylic acid groups. The alkyl or alkenyl group may be branched. The alkyl group may be cyclic. Useful dicarboxylic acids may include propanedioic acid, butanedioic acid, pentanedioic acid, hexanedioic acid, heptanedioic acid, octanedioic acid, nonanedioic acid, decanedioic acid, undecanedioic acid, dodecanedioic acid, hexadecanedioic acid, (Z)-butenedioic acid, (E)-butenedioic acid, pent-2-enedioic acid, dodec-2-enedioic acid, (2Z)-2-methylbut-2-enedioic acid, (2E,4E)-hexa-2,4-dienedioic acid, and sebacic acid. Aromatic dicarboxylic acids may be used, such as phthalic acid, isophthalic acid, terephthalic acid and 2,6-naphthalenedicarboxylic acid. Mixtures of two or more dicarboxylic acid may be used, as mixtures of different dicarboxylic acids may aid in disrupting the structural regularity of the polyamide, thereby significantly reducing or eliminating crystallinity in the resulting polyamide component.

In some embodiments, the dicarboxylic dimer acid may include at least one alkyl or alkenyl group and may contain 12 to 100 carbon atoms, 16 to 100 carbon atoms, or 18 to 100 carbon atoms and is characterized by having two carboxylic acid groups. The dimer acid may be saturated or partially unsaturated. In some embodiments, the dimer acid may be a dimer of a fatty acid. The phrase “fatty acid,” as used herein means an organic compound composed of an alkyl or alkenyl group containing 5 to 22 carbon atoms and characterized by a terminal carboxylic acid group. Useful fatty acids are disclosed in “Fatty Acids in Industry: Processes, Properties, Derivatives, Applications”, Chapter 7, pp 153-175, Marcel Dekker, Inc., 1989. In some embodiments, the dimer acid may be formed by the dimerization of unsaturated fatty acids having 18 carbon atoms such as oleic acid or tall oil fatty acid. The dimer acids are often at least partially unsaturated and often contain 36 carbon atoms. The dimer acids may be relatively high molecular weight and made up of mixtures comprising various ratios of a variety of large or relatively high molecular weight substituted cyclohexenecarboxylic acids, predominately 36-carbon dicarboxylic dimer acid. Component structures may be acyclic, cyclic (monocyclic or bicyclic) or aromatic, as shown below.

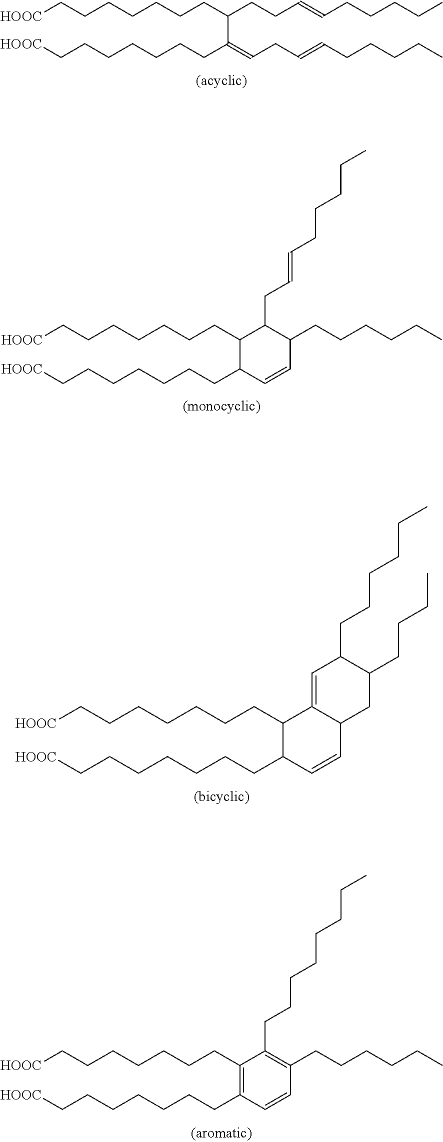 [SMILES: CCCCC/C=C/C/C=C(/CCCCCCCC(=O)O)C(CC/C=C/CCCCC)CCCCCCCC(=O)O ; CCCCC/C=C/CC1C(CCCCCC)C=CC(CCCCCCCC(=O)O)C1CCCCCCCC(=O)O ; CCCCCCC1C=C2C(C=CC(CCCCCCCC(=O)O)C2CCCCCCCC(=O)O)CC1CCCC ; CCCCCCCCc1c(CCCCCC)ccc(CCCCCCCC(=O)O)c1CCCCCCCC(=O)O]

The dimer acids may be prepared by condensing unsaturated monofunctional carboxylic acids such as oleic, linoleic, soya or tall oil acid through their olefinically unsaturated groups, in the presence of catalysts such as acidic clays. The distribution of the various structures in dimer acids (nominally C₃₆ dibasic acids) depends upon the unsaturated acid used in their manufacture. Typically, oleic acid gives a dicarboxylic dimer acid containing about 38% acyclics, about 56% mono- and bicyclics, and about 6% aromatics. Soya acid gives a dicarboxylic dimer acid containing about 24% acyclics, about 58% mono- and bicyclics and about 18% aromatics. Tall oil acid gives a dicarboxylic dimer acid containing about 13% acyclics, about 75% mono- and bicyclics and about 12% aromatics. The dimerization procedure also produces trimer acids. The commercial dimer acid products are typically purified by distillation to produce a range of dicarboxylic acid content. Useful dimer acids contain at least 80% dicarboxylic acid, more preferably 90% dicarboxylic acid content, even more preferably at least 95% dicarboxylic acid content. For certain applications, it may be advantageous to further purify the dimer acid by color reduction techniques including hydrogenation of the unsaturation, as disclosed in U.S. Pat. No. 3,595,887, which is incorporate herein by reference in its entirety. Hydrogenated dimer acids may also provide increased oxidative stability at elevated temperatures. Other useful dimer acids are disclosed in Kirk-Othmer Encyclopedia of Chemical Technology, Organic Chemicals: Dimer Acids (ISBN 9780471238966), copyright 1999-2014, John Wiley and Sons, Inc. Commercially available dicarboxylic dimer acids are available under the trade designation EMPOL1008 and EMPOL1061 both from BASF, Florham Park, N.J. and PRIPOL 1006, PRIPOL 1009, PRIPOL 1013, PRIPOL 1017 and PRIPOL 1025 all from Croda Inc., Edison, N.J., for example.

In some embodiments, the number average molecular weight of the dicarboxylic dimer acid may be between from 300 g/mol to 1400 g/mol, between from 300 g/mol to 1200 g/mol, between from 300 g/mol to 1000 g/mol or even between from 300 g/mol to 800 g/mol. In some embodiments, the number of carbon atoms in the dicarboxylic dimer acid may be between from 12 to 100, between from 20 to 100, between from 30 to 100, between from 12 to 80, between from 20 to 80, between from 30 to 80, between from 12 to 60, between from 20 to 60 or even between from 30 to 60. The mole fraction of dicarboxylic dimer acid included as the dicarboxylic acid may be between from 0.10 to 1.00, based on the total moles of dicarboxylic acid used to form the polyamide component. In some embodiments the, mole fraction of dicarboxylic dimer acid included as the dicarboxylic acid, is between from 0.10 to 1.00, between from 0.30 to 1.00, between from 0.50 to 1.00, between from 0.70 to 1.00, between from 0.80 to 1.00, between from 0.90 to 1.00, between from 0.10 to 0.98, between from 0.30 to 0.98, between from 0.50 to 0.98, between from 0.70 to 0.98, between from 0.80 to 0.98, or even between from 0.90 to 0.98, based on the total moles of dicarboxylic acid used to form the polyamide component. In some embodiments, the mole fraction of dicarboxylic dimer acid included as the dicarboxylic acid is 1.00, based on the total moles of dicarboxylic acid used to form the polyamide component. Mixtures of two or more dimer acids may be used.

In some embodiments, in addition to the diacid component, the reactants of the first polyamide component may include one or more triacids.

In some embodiments, the diamine component may include one or more secondary diamines or one or more secondary/primary hybrid diamines and, optionally, one or more primary diamines.

In some embodiments, suitable secondary or secondary/primary hybrid amines may have the formula: R1-NH—R2-NH—R1

where R2 is an:
alkylene (e.g. —CH2CH2CH2-),
branched alkylene (—CH2CH(Me)CH2-),
cycloalkylene (e.g. -cyclohexylene-CH2-cyclohexylene-),
substituted or unsubstituted arylene (e.g. -1,4-Phenylene-),
heteroalkylene (e.g. —CH2CH2-O—CH2CH2- or any other Jeffamine), or
heterocycloalkylene (e.g. —CH2-furan ring-CH2-)
   and each R1, independently, is a:
linear or branched alkyl (e.g. -Me, -isopropyl),
cycloalkyl (e.g. -cyclohexyl),
aryl (e.g. -phenyl),
heteroalkyl (e.g. —CH2CH2-O—CH3),
heteroaryl (e.g., -2-substituted-pyridyl), or
hydrogen atom,
with the proviso that both R1s are not hydrogen atoms, or
the R1 groups are alkylene or branched alkylene and form a heterocyclic compound (e.g. piperazine)

Suitable secondary diamines may include, for example, piperazine, 1,3-Di-4-piperidylpropane, cyclohexanamine, and 4,4′-methylenebis[N-(1-methylpropyl). In some embodiments, suitable secondary/primary hybrid diamines (i.e., diamines having a secondary amine and a primary amine) include, for example, aminoethyl piperazine. In some embodiments, the secondary/primary hybrid diamines may not be present, or may be present in an amount of less than 50 mol. %, less than 30 mol. %, less than 10 mol. %, or less than 5 mol. %, based on the total moles of the secondary or secondary/primary hybrid amines. In some embodiments, the number average molecular weight of suitable secondary diamines or secondary/primary hybrid diamines may be from 30 g/mol to 5000 g/mol, 30 g/mol to 500 g/mol, or 50 g/mol to 100 g/mol.

In some embodiments, the diamine component may, in addition to the secondary or secondary/primary hybrid amine, include a primary diamine, such as an aliphatic or aromatic primary amine. Suitable primary amines include, for example, ethylenediamine, m-xylylenediamine, 1,6-hexanediamine, o-toluidine, or 1,3-benzenedimethanamine. In some embodiments, the number average molecular weight of suitable primary diamines may be from 30 g/mol to 5000 g/mol, 30 g/mol to 500 g/mol, or 50 g/mol to 100 g/mol.

In some embodiments, the secondary or secondary/primary hybrid diamines, alone or in combination, may be present in the diamine component in an amount of from 50-100 mol %, 70-100 mol %, 90-100 mol %, 50-99 mol %, 70-99 mol %, 90-99 mol %, 95-100 mol %, or 95-99 mol %, or 99-100 mol %, based on the total moles of the diamine component. In some embodiments, the secondary or secondary/primary hybrid diamines, alone or in combination, may be present in the diamine component in an amount of in an amount of at least 50 mol %, at least 70 mol %, at least 90 mol %, at least 95 mol %, or at least 99 mol %, based on the total moles of the diamine component.

In some embodiments, primary amines may not be present in the diamine component, or may be present in the diamine component in an amount of between 1-10 mol % or 1-5 mol %, based on the total moles of the diamine component. In some embodiments, the mole ratio of diamine to diacid in the first polyamide component may be between 1 and 5, 1 and 4, 1.1 and 4, or 1.2 and 3.

In some embodiments, the polyamides of the first polyamide component may be formed following a conventional condensation reaction between at least one of the above described diacids and at least one of the above described diamines. Mixtures of at least two diacid types with at least one diamine, mixtures of at least two diamine types with at least one diacid type, or mixtures of at least two diacid types with at least two diamine types may be used. The polyamides of the first polyamide component may be amine terminated or include amine end-groups. Amine termination can be obtained by using the appropriate stoichiometric ratio of amine groups to acid groups, e.g. the appropriate stoichiometric ratio of diamine and diacid during the synthesis of the polyamide.

In some embodiments, in addition to the diamine component, the reactants of the first polyamide component may include one or more triamines.

As discussed above, the polyamide composition of the present disclosure may include a second polyamide component. In some embodiments, the second polyamide component may be different than the first polyamide component. In some embodiments, the second polyamide component may include a multifunctional polyamidoamine or a hotmelt dimer acid based polyamide such as those described in U.S. Pat. No. 3,377,303 (Peerman et al.). In some embodiments, suitable multifunctional polyamidoamines include those described in U.S. Pat. No. 2,705,223 (Renfrew et al.), which is herein incorporated by reference in its entirety. Commercially available multifunctional polyamidoamines are available under the trade designation VERSAMID 150 and VERSAMID 115, both from Gabriel Chemicals, Akron, Ohio, for example. Commercially available hotmelt polyamides are available under the trade designation UNI-REZ 2651 and UNI-REZ 2671, both from Arizona Chemical, Jacksonville, Fla., for example. In some embodiments, the polyamides of the second polyamide component may be liquid at room temperature (e.g., a viscous liquid of 500-50,000 cP). It is to be appreciated that polyamides of the second polyamide component, alone, were discovered to be inadequate in enhancing the elongation at break of the curable compositions, while maintaining good adhesion to metallic substrates. Rather, it was discovered that polyamides having tertiary amides in the backbone provided these desired attributes.

In some embodiments, the polyamide compositions of the present disclosure may include the first polyamide component in an amount of between 50 wt. % and 100 wt. %, 75 wt. % and 100 wt. %, 95 wt. % and 100 wt. %, 50 wt. % and 95 wt. %, or 75 wt. % and 95 wt. %, based on the total weight of polyamide in the polyamide composition. In some embodiments, the polyamide compositions of the present disclosure may include the first polyamide component in an amount of at least 50 wt. % at least 70 wt. %, at least 90 wt. %, or at least 95 wt. %, based on the total weight of polyamide in the polyamide composition. The polyamide compositions of the present disclosure may include the second polyamide component in an amount of between 0.01 wt. % and 50 wt. %, 0.1 wt. % and 25 wt. %, 0.5 wt. % and 10 wt. %, or 1 and 5 wt. %, based on the total weight of polyamide in the polyamide composition.

In some embodiments, the polyamide compositions of the present disclosure may include polyamides in an amount of between 5 wt. % and 40 wt. %, 10 wt. % and 30 wt. %, 15 wt. % and 30 wt. %, or 20 wt. % and 30 wt. %, (or may be even higher (up to 95%, 99%, or 100%) for curable compositions that do not include fillers) based on the total weight of the polyamide composition.

In some embodiments, the curable compositions of the present disclosure may include one or more amino functional compounds having at least two amino-groups. In some embodiments, the amino groups may be primary amino, secondary amino, or tertiary amino. In some embodiments, the amino functional compounds may include from 2-20, 3-18, or 4-15 carbon atoms. In some embodiments, the amino functional compounds may include aliphatic, cycloaliphatic, or aromatic diamines. In illustrative embodiments, the diamines may include di-primary amines with an average molecular weight of 30 to 600 or 60 to 400. In some embodiments, suitable diamines may include alkylene polyamines such as 1,3-diaminopropane, 1, 6-hexamethylene diamine, ethylenediamine, 1, 10-decamethylene diamine, diethylene triamine, triethylenetriamine, tetraethylenepentamine, 2-methylpentamethylenediamine; cycloaliphatic diamines such as 1,4-, 1,3-, and 1,2-diaminocyclohexane, 4,4′-, 2,4′-, 2,2′-diamino dicyclohexylmethane, 3-aminomethyl-3, 5, 5-trimethylcyclohexylamine, 1,4-, and 1,3-diaminomethylcyclohexane, 3(4),8(9)-Bis(aminomethyl)-tricyclo[5.2.1.0(2.6)]decane, bicyclo[2.2.1]heptanebis(methylamine); aromatic diamines such as meta-xylene diamine; and other amine curing agents, such as ethanolamine, methylimino-bis (propyl) amine, aminoethyl-piperazine, polyoxyethylene diamines, or polyoxypropylene diamines or triamines.

In some embodiments, in addition to the diamines, the cured compositions may include one or more triamines.

In some embodiments, the curable compositions of the present disclosure may include one or more multifunctional (meth)acrylate components. In some embodiments, the multifunctional (meth)acrylate components may function as crosslinkers. In various embodiments, the multifunctional (meth)acrylates may include multiple (meth)acryloyl groups including di(meth)acrylates, tri(meth)acrylates, tetra(meth)acrylates, or penta(meth)acrylates. The multifunctional (meth)acrylates can be formed, for example, by reacting (meth)acrylic acid with a polyhydric alcohol (i.e., an alcohol having at least two hydroxyl groups). The polyhydric alcohol may have two, three, four, or five hydroxyl groups.

In some embodiments, the multifunctional (meth)acrylate components may include at least two (meth)acryloyl groups. Exemplary multifunctional acrylates of this type may include, 1,2-ethanediol diacrylate, 1,3-propanediol diacrylate, 1,9-nonanediol diacrylate, 1, 12-dodecanediol diacrylate, 1,4-butanediol diacrylate, 1,6-hexanediol diacrylate, butylene glycol diacrylate, bisphenol A diacrylate, diethylene glycol diacrylate, triethylene glycol diacrylate, tetraethylene glycol diacrylate, tripropylene glycol diacrylate, polyethylene glycol diacrylate, polypropylene glycol diacrylate, polyethylene/polypropylene copolymer diacrylate, polybutadiene di(meth)acrylate, propoxylated glycerin tri(meth)acrylate, and neopentylglycol hydroxypivalate diacrylate modified caprolactone. In some embodiments, the multifunctional acrylate components may include three or four (meth)acryloyl groups. Exemplary multifunctional acrylates of this type may include trimethylolpropane triacrylate (e.g., commercially available under the trade designation TMPTA-N from Cytec Industries, Inc., Smyrna, GA and under the trade designation SR-351 from Sartomer), pentaerythritol triacrylate (e.g., commercially available under the trade designation SR-444 from Sartomer), tris(2-hydroxyethylisocyanurate) triacrylate (e.g., commercially available under the trade designation SR-368 from Sartomer), a mixture of pentaerythritol triacrylate and pentaerythritol tetraacrylate (e.g., commercially available from Allnex under the trade designation PETIA, pentaerythritol tetraacrylate (e.g., commercially available under the trade designation SR-295 from Sartomer), di-trimethylolpropane tetraacrylate (e.g., commercially available under the trade designation SR-355 from Sartomer), or ethoxylated pentaerythritol tetraacrylate (e.g., commercially available under the trade designation SR-494 from Sartomer). In some embodiments, the multifunctional acrylate components may include five (meth)acryloyl groups. Exemplary multifunctional acrylates of this type may include dipentaerythritol pentaacrylate (e.g., commercially available under the trade designation SR-399 from Sartomer).

In some embodiments, the epoxy composition may be present in the curable compositions of the present disclosure in an amount of between 0.2 wt. % and 50 wt. %, 0.5 wt. % and 40 wt. %, 1 wt. % and 30 wt. %, 1.5 wt. % and 20 wt. %, or 2 wt. % and 10 wt. %, based on the total weight of the curable composition. In some embodiments, the epoxy composition may be present in the curable compositions of the present disclosure in an amount of at least 0.2 wt. %, at least 0.5 wt. %, at least 1 wt. %, at least 2 wt. %, at least 5 wt. %, or at least 10 wt. %, based on the total weight of the curable composition. In some embodiments, the polyamide composition may be present in the curable compositions of the present disclosure in an amount of between 1 wt. % and 50 wt. %, 2 wt. % and 40 wt. %, 4 wt. % and 30 wt. %, or 5 wt. % and 20 wt., based on the total weight of the curable composition. In some embodiments, the polyamide composition may be present in the curable compositions of the present disclosure in an amount of at least 2 wt. %, at least 5 wt. %, at least 10 wt. %, or at least 20 wt. %, based on the total weight of the curable composition.

In some embodiments, the epoxy and polyamide compositions may be present in the curable compositions based on stoichiometric ratios of the functional groups of the respective components. For example, the relative amounts of the epoxy and polyamide compositions may be based on the stoichiometric ratio from (1:1) to (1:2), or from (1:1) to (1:1.5) or from (1:1) to (1:1.02) of the amine hydrogen (N—H) or amine groups of the polyamide composition and the oxirane groups of the epoxy composition. Employing such relative amounts may be advantageous in that it can reduce the amount of residual unreacted polyamide or epoxy in the cured composition, which residual components can migrate or provide environmental or health challenges.

In some embodiments, the short-chain diamines may be present in the curable compositions of the present disclosure in an amount of between 0.2 wt. % and 30 wt. %, 0.5 wt. % and 20 wt. %, 1 wt. % and 15 wt. %, 1.5 wt. % and 10 wt. %, or 2 wt. % and 5 wt. %, based on the total weight of the curable composition. In some embodiments, the short-chain diamines may be present in the curable compositions of the present disclosure in an amount of at least 0.2 wt. %, at least 0.5 wt. %, at least 1 wt. %, at least 1.5 wt. %, at least 2 wt. %, or at least 10 wt. %, based on the total weight of the curable composition. In some embodiments, the multifunctional acrylates may be present in the curable compositions of the present disclosure in an amount of between 0.5 wt. % and 50 wt. %, 1 wt. % and 40 wt. %, 2 wt. % and 30 wt. %, or 4 wt. % and 20 wt. %, based on the total weight of the curable composition. In some embodiments, the multifunctional acrylates may be present in the curable compositions of the present disclosure in an amount of at least 0.5 wt. %, at least 1 wt. %, at least 2 wt. %, at least 4 wt. %, at least 10 wt. %, or at least 20 wt. %, based on the total weight of the curable composition.

In some embodiments, the curable compositions of the present disclosure may be provided (e.g., packaged) as a two-part composition, in which a first part includes the above-described epoxy composition and multifunctional acrylate, and a second part includes the above described polyamide composition and the short-chain diamine. The other components of the curable adhesive composition (e.g., inorganic fillers, tougheners, dispersants, catalysts, antioxidants, and the like), described in further detail below, can be included in one or both of the first and second parts. The present disclosure further provides a dispenser comprising a first chamber and a second chamber. The first chamber comprises the first part, and the second chamber comprises the second part.

The curable compositions of the present disclosure include one or more inorganic fillers (e.g. thermally conductive inorganic fillers) in an amount of at least 25 wt. %, at least 35 wt. %, at least 45 wt. %, at least 50 wt. %, at least 55 wt. %, at least 60 wt. %, at least 70 wt. %, at least 80 wt. %, based on the total weight of the curable composition. In some embodiments, inorganic filler loadings may be between 25 and 95 wt. %, between 35 and 90 wt. %, between 55 and 85 wt. %, or between 70 and 85 wt. %, based on the total weight of the curable composition.

Generally, any known thermally conductive fillers may be used, although electrically insulating fillers may be preferred where breakthrough voltage is a concern. Suitable electrically insulating, thermally conductive fillers include ceramics such as oxides, hydroxides, oxyhydroxides, silicates, borides, carbides, and nitrides. Suitable ceramic fillers include, e.g., silicon oxide (e.g, fused silica), aluminum oxide, aluminum trihydroxide (ATH), boron nitride, silicon carbide, and beryllium oxide. In some embodiments, the thermally conductive filler includes ATH. It is to be appreciated that while ATH is not generally used in the polyurethane based compositions commonly employed in thermal management materials because of its reactivity with isocyanate species and the resultant formulation difficulties, the curable compositions of the present disclosure are able to incorporate such inorganic fillers without drawback. In some embodiments, the thermally conductive filler includes fused silica. Other thermally conducting fillers include carbon based materials such as graphite and metals such as aluminum and copper.

Thermally conductive filler particles are available in numerous shapes, e.g. spheres, irregular, platelike, & acicular. Through-plane thermal conductivity may be important in certain applications. Therefore, in some embodiments, generally symmetrical (e.g., spherical or semi-spherical) fillers may be employed. To facilitate dispersion and increase filler loading, in some embodiments, the thermally conductive fillers may be surface-treated or coated. Generally, any known surface treatments and coatings may be suitable, including those based on silane, titanate, zirconate, aluminate, and organic acid chemistries. In some embodiments, the thermally conductive filler particles may include silane surface treated particles (i.e., particles having surface-bonded organic silanes). For powder handling purposes, many fillers are available as polycrystalline agglomerates or aggregates with or without binder. To facilitate high thermal conductivity formulations, some embodiments may include mixtures of particles and agglomerates in various size and mixtures.

In some embodiments, the thermally conductive filler particles include spherical alumina, semispherical alumina, or irregular alumina. In some embodiments, the thermally conductive filler particles include spherical alumina and semispherical alumina.

In some embodiments, in addition to the polyamides of the present disclosure (which may be considered tougheners), the curable compositions of the present disclosure may also include one or more epoxy toughening agents. Such toughening agents may be useful, for example, for improving the properties (e.g., peel strength) of some cured epoxies, for example, so that they do not undergo brittle failure in a fracture. The toughening agent (e.g., an elastomeric resin or elastomeric filler) may or may not be covalently bonded to the curable epoxy and ultimately the crosslinked network. In some embodiments, the toughening agent may include an epoxy-terminated compound, which can be incorporated into the polymer backbone. Examples of useful toughening agents, which may also be referred to as elastomeric modifiers, include polymeric compounds having both a rubbery phase and a thermoplastic phase such as graft copolymers having a polymerized diene rubbery core and a polyacrylate or polymethacrylate shell; graft copolymers having a rubbery core with a polyacrylate or polymethacrylate shell; elastomeric particles polymerized in situ in the epoxide from free-radical polymerizable monomers and a copolymeric stabilizer; elastomer molecules such as polyurethanes and thermoplastic elastomers; separate elastomer precursor molecules; combination molecules that include epoxy-resin segments and elastomeric segments; and, mixtures of such separate and combination molecules. The combination molecules may be prepared by reacting epoxy resin materials with elastomeric segments; the reaction leaving reactive functional groups, such as unreacted epoxy groups, on the reaction product. The use of tougheners in epoxy resins is described in the Advances in Chemistry Series No. 208 entitled “Rubbery-Modified Thermoset Resins”, edited by C. K. Riew and J. K. Gillham, American Chemical Society, Washington, 1984. The amount of toughening agent to be used depends in part upon the final physical characteristics of the cured resin desired.

In some embodiments, the toughening agent in the curable compositions of the present disclosure may include graft copolymers having a polymerized diene rubbery backbone or core to which is grafted a shell of an acrylic acid ester or methacrylic acid ester, monovinyl aromatic hydrocarbon, or a mixture thereof, such as those disclosed in U.S. Pat. No. 3,496,250 (Czerwinski). Rubbery backbones can comprise polymerized butadiene or a polymerized mixture of butadiene and styrene. Shells comprising polymerized methacrylic acid esters can be lower alkyl (C₁₋₄) methacrylates. Monovinyl aromatic hydrocarbons can be styrene, alpha-me thylstyrene, vinyltoluene, vinylxylene, ethylvinylbenzene, isopropylstyrene, chlorostyrene, dichlorostyrene, and ethylchlorostyrene.

Further examples of useful toughening agents are acrylate core-shell graft copolymers wherein the core or backbone is a polyacrylate polymer having a glass transition temperature (T_{g}) below about 0° C., such as poly(butyl acrylate) or poly(isooctyl acrylate) to which is grafted a polymethacrylate polymer shell having a T_{g} about 25° C. such as poly(methyl methacrylate). For acrylic core/shell materials “core” will be understood to be acrylic polymer having T_{g}<0° C. and “shell” will be understood to be an acrylic polymer having T_{g}>25° C. Some core/shell toughening agents (e.g., including acrylic core/shell materials and methacrylate-butadiene-styrene (MBS) copolymers wherein the core is crosslinked styrene/butadiene rubber and the shell is polymethylacrylate) are commercially available, for example, from Dow Chemical Company under the trade designation “PARALOID”.

Another useful core-shell rubber is described in U.S. Pat. Appl. Publ. No. 2007/0027233 (Yamaguchi et al.). Core-shell rubber particles as described in this document include a cross-linked rubber core, in most cases being a cross-linked copolymer of butadiene, and a shell which is preferably a copolymer of styrene, methyl methacrylate, glycidyl methacrylate and optionally acrylonitrile. The core-shell rubber can be dispersed in a polymer or an epoxy resin. Examples of useful core-shell rubbers include those sold by Kaneka Corporation under the designation Kaneka KANE ACE, including the Kaneka KANE ACE 15 and 120 series of products, including Kaneka “KANE ACE MX 153”, Kaneka “KANE ACE MX 154”, Kaneka “KANE ACE MX 156”, Kaneka “KANE ACE MX 257” and Kaneka “KANE ACE MX 120” core-shell rubber dispersions, and mixtures thereof. The products contain the core-shell rubber (CSR) particles pre-dispersed in an epoxy resin, at various concentrations. For example, “KANE ACE MX 153” core-shell rubber dispersion comprises 33% CSR, “KANE ACE MX 154” core-shell rubber dispersion comprises 40% CSR, and “KANE ACE MX 156” core-shell rubber dispersions comprise 25% CSR.

Other useful toughening agents include carboxyl- and amine-terminated acrylonitrile/butadiene elastomers such as those obtained from Emerald Performance Materials, Akron, Ohio, under the trade designation “HYPRO” (e.g., CTBN and ATBN grades); carboxyl- and amine-terminated butadiene polymers such as those obtained from Emerald Performance Materials under the trade designation “HYPRO” (e.g., CTB grade); amine-functional polyethers such as any of those described above; and amine-functional polyurethanes such as those described in U.S. Pat. Appl. No. 2013/0037213 (Frick et al.).

In some embodiments, the toughening agent may include an acrylic core/shell polymer; a styrene-butadiene/methacrylate core/shell polymer; a polyether polymer; a carboxyl- or amino-terminated acrylonitrile/butadiene; a carboxylated butadiene, a polyurethane, or a combination thereof.

In some embodiments, toughening agents (excluding polyamides) may be present in the curable composition (or the epoxy composition) in an amount between 0.1 and 10 wt. %, 0.1 and 5 wt. %, 0.5 and 5 wt. %, 1 and 5 wt. %, or 1 and 3 wt. %, based on the total weight of any or all of the epoxy composition or the curable composition.

In some embodiments, the curable compositions according to the present disclosure may include one or more dispersants. Generally, the dispersants may act to stabilize the inorganic filler particles in the composition—without dispersant, the particles may aggregate, thus adversely affecting the benefit of the particles in the composition. Suitable dispersants may depend on the specific identity and surface chemistry of filler. In some embodiments, suitable dispersants according to the present disclosure may include at least a binding group and a compatibilizing segment. The binding group may be ionically bonded to the particle surface. Examples of binding groups for alumina particles include phosphoric acid, phosphonic acid, sulfonic acid, carboxylic acid, and amine. The compatibilizing segment may be selected to be miscible with the curable matrix. For epoxy resin and amide matrices, useful compatibilizing agents may include polyalkylene oxides, e.g., polypropylene oxide, polyethylene oxide, as well as polycaprolactones, and combinations thereof. Commercially available examples include BYK W-9010 (BYK Additives and Instruments), BYK W-9012 (BYK Additives and Instruments), Disberbyk 180 (BYK Additives and Instruments), and Solplus D510 (Lubrizol Corporation),In some embodiments, the dispersants may be present in the curable composition (or the epoxy composition or the amide composition) in an amount between 0.1 and 10 wt. %, 0.1 and 5 wt. %, 0.5 and 3 wt. %, or 0.5 and 2 wt. %, based on the total weight of any or all of the epoxy composition, the polyamide composition, or the curable composition.

In some embodiments, the dispersant may be pre-mixed with the inorganic filler prior to incorporating into any or all of the epoxy, polyamide, or curable compositions. Such pre-mixing may facilitate the filled systems behaving like Newtonian fluids or enable shear-thinning effects behavior.

In some embodiments, the curable compositions according to the present disclosure may include one or more catalysts. Generally, the catalysts may act to accelerate the cure of the curable composition. In some embodiments, the catalyst may include a Lewis acid. Such Lewis acids may include metal salts, triorganoborates including trialkylborates (including those represented by the formula B(OR)3, wherein each R is independently alkyl) and the like, and combinations thereof. Useful metal salts include those that comprise at least one metal cation that acts as a Lewis acid. Preferred metal salts include metal salts of organic acids (metal carboxylates (including both aliphatic and aromatic carboxylates), sulfonic acid (like trifluoromethanesulfonic acid), mineral acid (like nitric acid) and combinations thereof. Useful metal cations include those that have at least one vacant orbital. Suitable metals include calcium, zinc, iron, copper, bismuth, aluminum, magnesium, or combinations thereof; calcium, zinc, bismuth, aluminum, magnesium, or combinations thereof; or calcium, zinc, bismuth, or combinations thereof; or calcium). In some embodiment the catalyst may include calcium triflate or calcium nitrate. Alternatively, or additionally, in some embodiments, the catalysts may include include phosphoric acid; or a combination of N-(3-aminopropyl) piperazine and salicylic acid that is synergistic for accelerating the cure of polyglycidyl ether of a polyhydric phenol cured with a polyoxyalkylenepolyamine, which is discussed in U.S. Pat. No. 3,639,928 (Bentley et al.) an is herein incorporated by reference in its entirety. In some embodiments, the catalysts may be present in the curable composition (or the epoxy composition or the amide composition) in an amount between 100 and 10,000 ppm or 200 and 5,000 ppm, based on the total weight and volume of any or all of the epoxy composition, the polyamide composition, or the curable composition.

In addition to the above discussed additives, further additives can be included in one or both of the first and second parts. For example, any or all of antioxidants/stabilizers, colorants, abrasive granules, thermal degradation stabilizers, light stabilizers, conductive particles, tackifiers, flow agents, bodying agents, flatting agents, inert fillers, binders, blowing agents, fungicides, bactericides, surfactants, plasticizers, and other additives known to those skilled in the art. These additives, if present, are added in an amount effective for their intended purpose.

In some embodiments, upon curing (i.e., the cured composition that is the reaction product of the curable composition), the curable compositions of the present disclosure may exhibit thermal, mechanical, and rheological properties that render the compositions particularly useful as thermally conductive gap fillers. For example, it is believed that that curable compositions of the present disclosure provide an optimal blend of tensile strength, elongation at break, and overlap shear strength for certain EV battery assembly applications.

In some embodiments, the cured compositions may have an elongation at break that ranges from 0.1 to 200%, 0.5 to 175%, 1 to 160%, or 5 to 160%, with the pulling rate between 0.8 and 1.5 mm/min for fully cured systems (for purposes of the present application, elongation at break values are as measured in accordance with ASTM D638-03, “Standard Test Method for Tensile Properties of Plastics.”); or at least 5%, at least 5.5%, at least 6%, at least 7%, at least 10%, at least 50%, at least 100%, or at least 150%, with the pulling rate between 0.8 and 1.5 mm/min for fully cured systems.

In some embodiments, the cured compositions may have an overlap shear strength on a bare aluminum substrate ranging from 1-30 N/mm², 2-30 N/mm², 1-25 N/mm², 4-20 N/mm², 6-20 N/mm², 2-16 N/mm², or 3-8 N/mm², for fully cured systems (for purposes of the present application, overlap sheer strength values are as measured on untreated aluminum substrates (i.e., aluminum substrates having no surface treatments or coatings other than native oxide layers) in accordance with EN 1465 Adhesives—Determination of tensile lap-shear strength of bonded assemblies).

In some embodiments, the cured compositions may have a tensile strength ranging from 0.5-16 N/mm², 1-10 N/mm², or 2-8 N/mm², with the pulling rate between 1 and 10% strain/min for fully cured systems (for purposes of the present application, tensile strength values are as measured in accordance with EN ISO 527-2 Tensile Test).

In some embodiments, the compositions may have a cure rate in the range of 10 minutes to 240 hours, 30 minutes to 72 hours, or 1 to 24 hours for complete curing at room temperature or 10 minutes to 6 hours, 10 minutes to 3 hours, or 30 minutes to 60 minutes for complete curing at 100° C., or 1 to 24 hours for complete curing at room temperature or 10 minutes to 6 hours, 10 minutes to 3 hours, or 30 minutes to 60 minutes for complete curing at 120° C.

In some embodiments, the compositions may have a green strength cure rate, at room temperature of less than 10 minutes, less than 11 minutes, less than 15 minutes, less than 20 minutes, or less than 30 minutes. For purposes of the present application, the green strength cure rate refers may be approximated in terms of the overlap shear strength build-up rate. In this regard, in some embodiments, upon a 10 minute cure at room temperature, the compositions may have an overlap shear strength of at least 0.2 MPa, at least 0.3 MPa, at least 0.5 MPa, or at least 0.8 MPa. For purposes of the present application, overlap shear strength values are as measured in accordance with EN 1465.

In some embodiments, upon curing, the curable compositions of the present disclosure may have a thermal conductivity ranging from 1.0 to 5 W/(m*K), 1.0 to 2 W/(m*K), or 1.4 to 1.8 W/(m*k) (for purposes of the present application, thermal conductivity values are as determined by, first, measuring diffusivity according to ASTM E1461-13, “Standard Test Method for Thermal Diffusivity by the Flash Method” and, then, calculating thermal conductivity from the measured thermal diffusivity, heat capacity, and density measurements according the formula:

k=α·cp·ρ, where k is the thermal conductivity in W/(m K), α is the thermal diffusivity in mm²/s, cp is the specific heat capacity in J/K-g, and ρ is the density in g/cm³. The sample thermal diffusivity can be measured using a Netzsch LFA 467 “HYPERFLASH” directly and relative to standard, respectively, according to ASTM E1461-13. Sample density can be measured using geometric methods, while the specific heat capacity can be measured using Differential Scanning calorimetry.)

In some embodiments, within 10 minutes of mixing of the epoxy composition and the amide composition, the viscosity of curable/partially cured composition measured at room temperature may range from 100 to 50000 poise, and at 60° C. may range from 100 to 50000 poise. Further regarding viscosity, the viscosity of the epoxy composition (prior to mixing) measured at room temperature may range from 100 to 100000 poise, and at 60° C. may range from 10 to 10000 poise; and the viscosity of the amide composition (prior to mixing) measured at room temperature may range from 100 to 100000 poise, and at 60° C. may range from 10 to 10000 poise (for purposes of the present application, viscosity values are as measured using a 40 mm parallel-plate geometry at 1% strain on a ARES Rheometer (TA Instruments, Wood Dale, Ill., US) equipped with a forced convection oven accessory, at angular frequencies ranging from 10-500 rad/s.)

The present disclosure is further directed to methods of making the above-described curable compositions, and certain of the components of the curable compositions. For example, in some embodiments, the above-described first polyamide component may be prepared by reacting one or more of the above-described diacids with one or more of the above-described diamines. In some embodiments, the reaction may take place at a temperature ranging from 50 to 300° C., 75 to 250° C., or 100 to 225° C., In some embodiments, the reaction may take place at atmospheric pressure (760 torr) or at a pressure of below 300 torr, below 100 torr, below 50 torr, or below 30 torr. The reaction end point may be determined by the lack of evolution of the water by-product. The reaction may also be conducted using heterogenous aqueous azeotropes such as toluene, xylene as solvents to remove the water by-product. In such a case, it may be advantageous to distill the azeotropic solvent from the product mixture once the reaction no longer produces water. Such distillations may be carried out at atmospheric pressure or under vacuum as noted above. It is also known to those skilled in the art that the polyamide may be formed by the reaction of the corresponding acid chlorides of the carboxylic acids discussed above with diamines discussed above. In such cases, the reaction may be carried out in non-reactive anhydrous solvents such as toluene, xylene, tetrahydrofuran, triethylamine, at temperatures below 50 C. In such cases, it may be advantageous to distill of the solvent at the end of the reaction. It may sometimes be desirable to include catalysts, defoamers, or antioxidants. Phosphoric acid may be used as a catalyst at 5-500 ppm, based on the total reactant mass. Silicone defoamers may be employed such as those sold by Dow-Corning (Midland, Mich., US) at 1-100 ppm. It may also be advantageous to use antioxidants such as octylated diphenylamine or phenolic antioxidants such as those sold by BASF (Ludwigshafen, Germany) under the IRGANOX tradename (e.g. IRGANOX 1010 or IRGANOX 1035).

In some embodiments, the curable compositions of the present disclosure may be prepared by, first, mixing the components of the epoxy composition (including any additives) and, separately, mixing the components of the amide composition (including any additives). The components of both the epoxy and amide composition may be mixed using any conventional mixing technique, including by use of a speed mixer. In embodiments in which dispersants are employed, the dispersant may be pre-mixed with the inorganic filler prior to incorporating into the composition. Next, the epoxy composition and the amide composition may be mixed using any conventional mixing technique to form the curable composition.

In some embodiments, the curable compositions of the present disclosure may be capable of curing without the use of catalyst or other cure agents. Generally, the curable compositions may cure at typical application conditions, e.g., at room temperature without the need for elevated temperatures or actinic radiation (e.g., ultraviolet light). In some embodiments, the first curable compositions cure at no greater than room temperature. In some embodiments, flash heating can be used, (e.g, IR light).

In some embodiments, the curable compositions of the present disclosure may be provided as a two-part composition. Generally, the two components of a two-part composition may be mixed prior to being applied to the substrates to be bonded. After mixing, the two-part composition may reach a desired handling strength, and ultimately achieve a desired final strength. Applying the curable composition can be carried out, for example, by dispensing the curable composition from a dispenser comprising a first chamber, a second chamber, and a mixing tip, wherein the first chamber comprises the first part, wherein the second chamber comprises the second part, and wherein the first and second chambers are coupled to the mixing tip to allow the first part and the second part to flow through the mixing tip.

The curable compositions of the present disclosure may be useful for coatings, shaped articles, adhesives (including structural and semi-structural adhesives), magnetic media, filled or reinforced composites, caulking and sealing compounds, casting and molding compounds, potting and encapsulating compounds, impregnating and coating compounds, conductive adhesives for electronics, protective coatings for electronics, as primers or adhesion-promoting layers, and other applications that are known to those skilled in the art. In some embodiments, the present disclosure provides an article comprising a substrate, having a cured coating of the curable composition thereon.

In some embodiments, the curable composition may function as a structural adhesive, i.e. the curable composition is capable of bonding a first substrate to a second substrate, after curing. Generally, the bond strength (e.g. peel strength, overlap shear strength, or impact strength) of a structural adhesive continues to build well after the initial cure time. In some embodiments, the present disclosure provides an article comprising a first substrate, a second substrate and a cured composition disposed between and adhering the first substrate to the second substrate, wherein the cured composition is the reaction product of the curable composition according to any one of the curable compositions of the present disclosure. In some embodiments, the first and/or second substrate may be at least one of a metal, a ceramic and a polymer, e.g. a thermoplastic.

The curable compositions may be coated onto substrates at useful thicknesses ranging from 5 microns to 10000 microns, 25 micrometers to 10000 micrometers, 100 micrometers to 5000 micrometers, or 250 micrometers to 1000 micrometers. Useful substrates can be of any nature and composition, and can be inorganic or organic. Representative examples of useful substrates include ceramics, siliceous substrates including glass, metal (e.g., aluminum or steel), natural and man-made stone, woven and nonwoven articles, polymeric materials, including thermoplastic and thermosets, (such as polymethyl (meth)acrylate, polycarbonate, polystyrene, styrene copolymers, such as styrene acrylonitrile copolymers, polyesters, polyethylene terephthalate), silicones, paints (such as those based on acrylic resins), powder coatings (such as polyurethane or hybrid powder coatings), and wood; and composites of the foregoing materials.

In another aspect, the present disclosure provides a coated article comprising a metal substrate comprising a coating of the uncured, partially cured or fully cured curable composition on at least one surface thereof. If the substrate has two major surfaces, the coating can be coated on one or both major surfaces of the metal substrate and can comprise additional layers, such as bonding, tying, protective, and topcoat layers. The metal substrate can be, for example, at least one of the inner and outer surfaces of a pipe, vessel, conduit, rod, profile shaped article, sheet or tube.

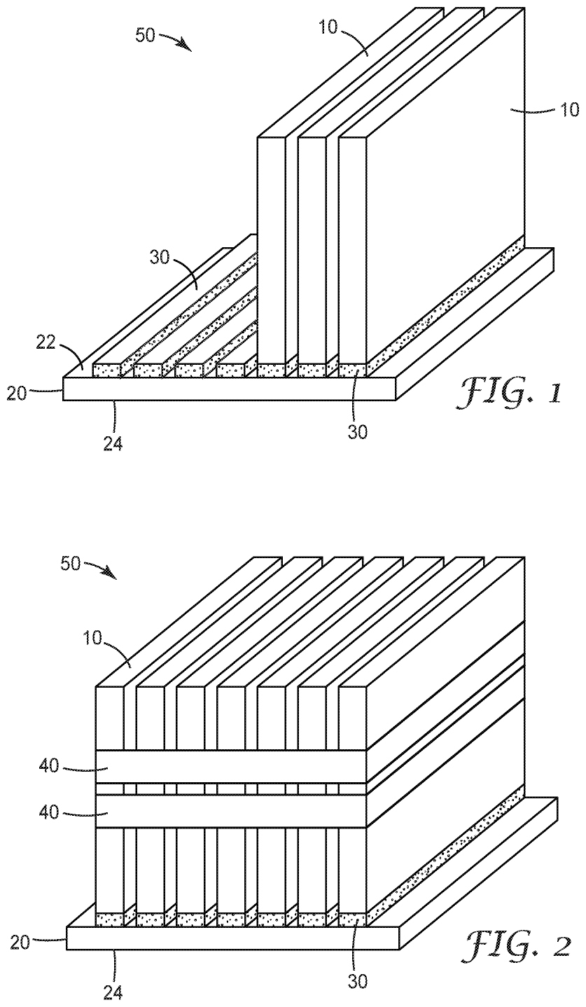

In some embodiments, the present disclosure is further directed to a battery module that includes the uncured, partially cured or fully cured curable compositions of the present disclosure. Components of a representative battery module during assembly are shown in FIG. 1, and an assembled battery module is shown in FIG. 2. Battery module 50 may be formed by positioning a plurality of battery cells 10 on first base plate 20. Generally, any known battery cell may be used including, e.g., hard case prismatic cells or pouch cells. The number, dimensions, and positions of the cells associated with a particular battery module may be adjusted to meet specific design and performance requirements. The constructions and designs of the base plate are well-known, and any base plate (typically metal base plates made of aluminum or steel) suitable for the intended application may be used.

Battery cells 10 may be connected to first base plate 20 through first layer 30 of a first curable composition according to any of the embodiments of the present disclosure. First layer 30 of the curable composition may provide first level thermal management where the battery cells are assembled in a battery module. As a voltage difference (e.g., a voltage difference of up to 2.3 Volts) is possible between the battery cells and the first base plate, breakthrough voltage may be an important safety feature for this layer. Therefore, in some embodiments, electrically insulating fillers like ceramics (typically alumina and boron nitride) may be preferred for use in the curable compositions.

In some embodiments, layer 30 may comprise a discrete pattern of the first curable composition applied to first surface 22 of first base plate 20, as shown in FIG. 1. For example, a pattern of the material to the desired lay-out of the battery cells may be applied, e.g., robotically applied, to the surface of the base plate. In some embodiments, the first layer may be formed as a coating of the first curable composition covering all or substantially all of the first surface of the first base plate. In alternative embodiments, the first layer may be formed by applying the curable composition directly to the battery cells and then mounting them to the first surface of the first base plate.

In some embodiments, the curable composition may need to accommodate dimensional variations of up to 2 mm, up to 4 mm, or even more. Therefore, in some embodiments, the first layer of the first curable composition may be at least 0.05 mm thick, e.g., at least 0.1 mm, or even at least 0.5 mm thick. Higher breakthrough voltages may require thicker layers depending on the electrical properties of the material, e.g., in some embodiments, at least 1, at least 2, or even at least 3 mm thick. Generally, to maximize heat conduction through the curable composition and to minimize cost, the curable composition layer should be as thin as possible, while still ensure good contact with the heat sink. Therefore, in some embodiments, the first layer is no greater than 5 mm thick, e.g., no greater than 4 mm thick, or even no greater than 2 mm thick.

As the first curable composition cures, the battery cells are held more firmly in-place. When curing is complete, the battery cells are finally fixed in their desired position, as illustrated in FIG. 2. Additional elements, such as bands 40 may be used to secure the cells for transport and further handling.

Generally, it is desirable for the curable composition to cure at typical application conditions, e.g., without the need for elevated temperatures or actinic radiation (e.g., ultraviolet light). In some embodiments, the first curable composition cures at room temperature, or no greater than 30° C., e.g., no greater than 25° C., or even no greater than 20° C.

In some embodiments, the time to cure is no greater than 60 minutes, e.g., no greater than 40 minutes, or even no greater than 20 minutes. Although very rapid cure (e.g., less than 5 minutes or even less than 1 minute) may be suitable for some applications, in some embodiments, an open time of at least 5 minutes, e.g., at least 10 minutes, or even at least 15 minutes may be desirable to allow time for positioning and repositioning of the battery cells. Generally, it is desirable to achieve the desired cure times without the use of expensive catalysts such as platinum.

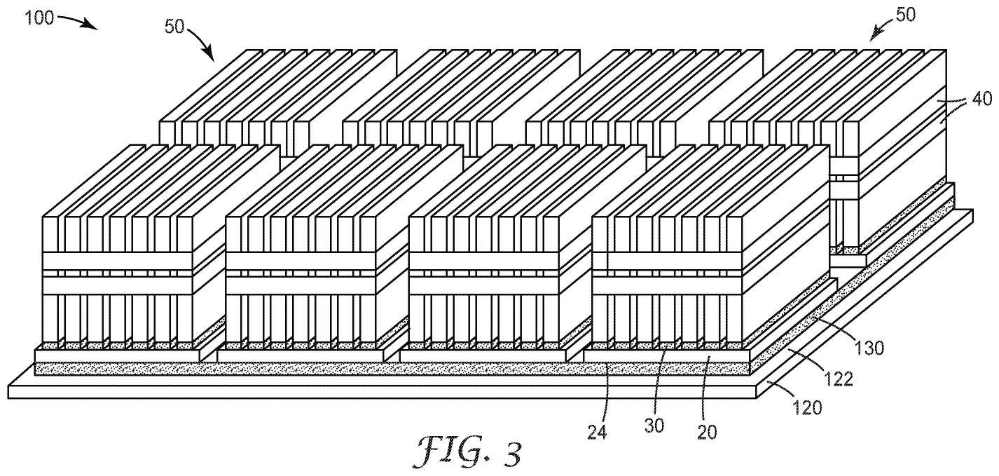

As shown in FIG. 3, a plurality of battery modules 50, such as those illustrated and described with respect to FIGS. 1 and 2, are assembled to form battery subunit 100. The number, dimensions, and positions of the modules associated with a particular battery subunit may be adjusted to meet specific design and performance requirements. The constructions and designs of the second base plate are well-known, and any base plate (typically metal base plates) suitable for the intended application may be used.

Individual battery modules 50 may be positioned on and connected to second base plate 120 through second layer 130 of a curable composition according to any of the embodiments of the present disclosure.

Second layer 130 of a second curable composition may be positioned between second surface 24 of first base plate 20 (see FIGS. 1 and 2) and first surface 122 of second base plate 120. The second curable composition may provide second level thermal management where the battery modules are assembled into battery subunits. At this level, breakthrough voltage may not be a requirement. Therefore, in some embodiments, electrically conductive fillers such as graphite and metallic fillers may be used or alone or in combinations with electrically insulating fillers like ceramics.

In some embodiments, the second layer 130 may be formed as coating of the second curable composition covering all or substantially all of first surface 122 of second base plate 120, as shown in FIG. 3. In some embodiments, the second layer may comprise a discrete pattern of the second curable composition applied to the surface of the second base plate. For example, a pattern of the material corresponding to the desired lay-out of the battery modules may be applied, e.g., robotically applied, to the surface of the second base plate. In alternative embodiments, the second layer may be formed by applying the second curable composition directly to second surface 24 of first base plate 20 (see FIGS. 1 and 2) and then mounting the modules to first surface 122 of second base plate 120.

The assembled battery subunits may be combined to form further structures. For example, as is known, battery modules may be combined with other elements such as battery control units to form a battery system, e.g., battery systems used in electric vehicles. In some embodiments, additional layers of curable compositions according to the present disclosure may be used in the assembly of such battery systems. For example, in some embodiments, thermally conductive gap filler according to the present disclosure may be used to mount and help cool the battery control unit.

### LISTING OF EMBODIMENTS

1. A curable composition comprising:

a polyamide composition comprising a first polyamide, the first polyamide comprising a tertiary amide in the backbone thereof and being amine terminated;

an amino functional compound comprising from 2 to 20 carbon atoms;

a multifunctional (meth)acrylate;

an epoxy resin; and

an inorganic filler, the inorganic filler being present an amount of at least 25 wt. %, based on the total weight of the curable composition.

2. The curable composition of embodiment 1, wherein the polyamide composition is present in the curable composition in an amount of between 1 and 50 wt. %, based on the total weight of the curable composition.
3. The curable composition of any one of the previous embodiments, wherein the amino functional compound is present in the curable composition in an amount of between 0.2 and 30 wt. %, based on the total weight of the curable composition.
4. The curable composition of any one of the previous embodiments, wherein the multifunctional (meth)acrylate is present in the curable composition in an amount of between 2 and 50 wt. %, based on the total weight of the curable composition.
5. The curable composition of any one of the previous embodiments, wherein the epoxy resin is present in the curable composition in an amount of between 0.2 and 50 wt. %, based on the total weight of the curable composition.
6. The curable composition of any one of the previous embodiments, wherein tertiary amides are present in the first polyamide in an amount of at least 50 mol. %, based on the total amide content present in the backbone of the first polyamide.
7. The curable composition of any one of the previous embodiments, wherein the first polyamide component comprises the reaction product of (i) a diacid; and (ii) a diamine, wherein the diamine comprises a secondary diamine or a secondary/primary hybrid diamine;
8. The curable composition of any one of the previous embodiments, the polyamide composition further comprising a second polyamide, wherein the second polyamide comprises a multifunctional polyamidoamine.
9. The curable composition of any one of the previous embodiments, wherein the first polyamide component is present in the polyamide composition in an amount of at least 50 wt. %, based on the total weight of polyamide in the polyamide composition.
10. The curable composition of any one of the previous embodiments, further comprising a catalyst comprising a Lewis acid.
11. The curable composition of any one of the previous embodiments, wherein the curable composition provides, upon curing, (i) an elongation at break of greater than 5.5%, and (ii) an overlap shear strength, on untreated aluminum, of 2-20 N/mm²
12. The curable composition of any one of the previous embodiments, wherein the curable composition provides, upon curing for no more than 10 minutes at room temperature, the composition exhibits an overlap shear strength of at least 0.2 MPa.
13. The curable composition of any one of the previous embodiments, wherein the curable composition provides, upon curing, a tensile strength of 0.5 to 16 N/mm2.
14. The curable composition of any one of the previous embodiments, wherein the curable composition provides, upon curing, an elongation at break of greater than 6%.
15. The curable composition of any one of the previous embodiments, wherein the curable composition provides, upon curing, an elongation at break of greater than 7%.
16. The curable composition of any one of the previous embodiments, wherein the inorganic filler comprises ATH.
17. The curable composition of any one of the previous embodiments, wherein the inorganic filler comprises alumina.
18. The curable composition of any one of the previous embodiments, wherein the inorganic filler comprises spherical alumina particles and semispherical alumina particles.
19. The curable composition of any one of the previous embodiments, wherein the inorganic filler comprises silane surface-treated particles.
20. The curable composition of any one of the previous embodiments, wherein the curable composition provides, upon curing, a thermal conductivity of 0.5-2 W/(mK)
21. The curable composition of any one of the previous embodiments, wherein the curable composition provides, upon curing, a flame retardancy of at least UL94-HB.
22. The curable composition of any one of the previous embodiments, wherein the curable composition provides, upon curing, the dielectric breakdown strength of greater than 5 kV/mm and electrical volume insulation resistance of at least 1×10⁹ Ohm cm.
23. The curable composition of any one of the previous embodiments, further comprising a dispersant comprising a binding group and a compatibilizing segment.
24. The curable composition of any one of the previous embodiments, wherein the amino functional compound comprises a diamine.
25. An article comprising a cured composition, wherein the cured composition is the reaction product of the curable composition according to any one of embodiments 1-24.
26. The article of embodiment 25, wherein the cured composition has a thickness between from 5 microns to 10000 microns.
27. The article of embodiment 25, further comprising a substrate having a surface, wherein the cured composition is disposed on the surface of the substrate.
28. The article of embodiment 27, wherein the substrate is a metal substrate.
29. An article comprising a first substrate, a second substrate and a cured composition disposed between and adhering the first substrate to the second substrate, wherein the cured composition is the reaction product of the curable composition according to any one of embodiments 1-24.
30. A battery module comprising a plurality of battery cells connected to a first base plate by a first layer of a curable composition according to any one of embodiments 1-24.
31. A method of making a battery module comprising: applying a first layer of a curable composition according to any one of embodiments 1-24 to a first surface of a first base plate, attaching a plurality of battery cells to the first layer to connect the battery cells to the first base plate, and curing the curable composition.

### EXAMPLES

Objects and advantages of this disclosure are further illustrated by the following comparative and illustrative examples. Unless otherwise noted, all parts, percentages, ratios, etc. in the examples and the rest of the specification are provided in parts by weight, and all reagents used in the examples were obtained, or are available, from general chemical suppliers such as, for example, Sigma-Aldrich Corp., Saint Louis, Mo., US. The following abbreviations are used herein: L=liter, mL=milliliter, min=minutes, hr=hours, g=grams, rpm=rotations per minute, μm=micrometers (10⁻⁶ m), ° C.=degrees Celsius.

### Preparation Procedures

TABLE 1
Materials Used

| | Materials | Purpose | Supplier | Location |
|---|---|---|---|---|
| Polyamide 1 | Liquid Polyamide | Crosslinker/ | Synthesis procedures | |
| | | Toughener | provided below | |
| Polyamide 2 | Liquid Polyamide | Crosslinker | Synthesis procedures | |
| | | | provided below | |
| Polyamide 3 | VERSAMID 150 | Crosslinker | Gabriel | Akron, OH, |
| | | | Chemicals | US |
| Amine 1 | DYTEK A | Crosslinker | TCI | Portland, |
| | | | | OR, US |
| Amine 2 | Ethylenediamine | Crosslinker | Alfa Aesar | Ward Hill, |
| | | | | MA, US |
| Amine 3 | TEPA | Crosslinker | TCI | Portland, |
| | | | | OR, US |
| Amine 4 | mXDA | Crosslinker | Acros | New Jersey |
| | | | Organics | |
| Filler 1 | Aluminum hydroxide | Thermally conductive | KC Industries | Korea |
| | (ATH, D50 = 17 μm) | filler | | |
| Filler 2 | Aluminum hydroxide | Thermally conductive | Huber | Edison, |
| | (ATH, D50 = 10 μm) | filler | | New Jersey, |
| | | | | US |
| Filler 3 | MARTOXID TM1250 | Thermally conductive | Huber | Edison, |
| | Alumina | filler | | New Jersey, |
| | | | | US |
| Filler 4 | BAK-40 Spherical | Thermally conductive | Bestry | China |
| | Alumina | filler | Performance | |
| | | | Materials | |
| Filler 5 | ATH (D50 = 17 μm) | Thermally conductive | Preparation procedures | |
| | surface treated with | filler | provided below | |
| | Phenyltrimethoxysilane | | | |
| Filler 6 | ATH (D50 = 17 μm) | Thermally conductive | Preparation procedures | |
| | surface treated with | filler | provided below | |
| | A1230 Silane | | | |
| Dispersant 1 | SOLPLUS D510 | Dispersant | Lubrizol | Wickliffe, |
| | | | | OH, US |
| Accelerator1 | DBU | Catalyst | Evonik | Troy Hills, |
| | | | | NJ, US |
| Accelerator2 | Calcium nitrate | Catalyst | Sigma Aldrich | St. Louis, |
| | tetrahydrate | | | MO, US |
| Accelerator3 | Calcium triflate | Catalyst | Sigma Aldrich | St. Louis, |
| | | | | MO, US |
| Epoxy 1 | EPON 828 | Crosslinker | Hexion | Columbus, |
| | | | | OH, US |
| Acrylate 1 | TMPTA | Crosslinker | Sartomer | Exton, PA, |
| | | | | US |

The two-part polyamide/epoxy/acrylate semi-structural adhesives with high thermal conductivity and fast curing profile were formulated using the materials listed in Table 1. The polyamide component (Part A) comprised one or more polyamides, a short-chain diamine, a thermally conductive filler, a dispersant, and an optional chain extender. The epoxy component (Part B) was comprised of an aromatic epoxy, a multifunctional acrylate, and thermally conductive filler. In some examples, Part B also contained a dispersant. Detailed formulations for Examples 1-13 and Comparative Examples CE 1-7 are provided in Tables 2, 3 and 4.

A speed mixer (SPEEDMIXER DAC 150.1 FVZ-K, FlackTek, Inc., Landrum, SC, US) was used to thoroughly mix the thermally conductive filler powders with resins for each part individually, using a speed of 3000 rpm for 3 min at room temperature. If a dispersant was used, pre-mixing of the dispersant with the thermally conductive filler (2000 rpm for 2 min) was performed before adding any other components.

Part A and Part B were mixed based on stoichiometric ratios of the functional groups: amine groups for Part A and oxirane/acrylate groups for Part B. Either hand or speed mixing was used for this purpose. The weight ratios of part A and part B for each Example and Comparative Example are listed in Tables 2, 3 and 4.

The volume percentage of filler in each composition was calculated using the weight percentages of filler and the density of the components.

TABLE 2
Composition of Comparative Examples and Examples Utilizing ATH Fillers

| | CE1 | Ex. 1 | Ex. 2 | Ex. 3 | Ex. 4 | Ex. 7 | Ex. 8 |
|---|---|---|---|---|---|---|---|
| | wt % | wt % | wt % | wt % | wt % | wt % | wt % |
| Part A | | | | | | | |
| Polyamide 1 | 18.22 | | | | | | |
| Polyamide 2 | | 16.53 | 16.15 | 15.25 | 16.1 | 11.5 | 11.5 |
| Polyamide 3 | 2.02 | 3.92 | 3.83 | 3.62 | 3.8 | 2.7 | 2.7 |
| Amine 1 | | — | — | 3.62 | 3.8 | 2.7 | 2.7 |
| Amine 2 | | 2.04 | — | — | — | — | — |
| Amine 3 | | — | 2.5 | — | — | — | — |
| Filler 1 | 78.03 | 75.27 | 75.27 | 75.29 | — | — | — |
| Filler 2 | | — | — | — | 75.1 | — | — |
| Filler 5 | | — | — | — | — | — | — |
| Filler 6 | | — | — | — | — | — | — |
| Filler 5 | | — | — | — | — | 82.4 | — |
| Filer 8 | | — | — | — | — | — | 82.4 |
| Dispersant 1 | 1.56 | 1.51 | 1.51 | 1.51 | 0.38 | — | — |
| Accelerator 1 | 0.16 | | | | | | |
| Accelerator 3 | | 0.74 | 0.74 | 0.72 | 0.76 | 0.70 | 0.70 |
| Part B | | | | | | | |
| Epoxy 1 | 18.7 | 4.59 | 4.59 | 4.59 | 5.0 | 8.0 | 8.0 |
| Acrylate 1 | | 8.68 | 8.68 | 8.68 | 9.5 | 15.1 | 15.1 |
| Filler 1 | 79.71 | 85.03 | 85.03 | 85.03 | — | — | — |
| Filler 2 | | — | — | — | 85.1 | — | — |
| Filler 5 | | — | — | — | — | — | — |
| Filler 6 | | — | — | — | — | — | — |
| Filler 5 | | — | — | — | — | 77.0 | — |
| Filler 6 | | — | — | — | — | — | 77.0 |
| Dispersant 1 | 1.59 | 1.7 | 1.7 | 1.7 | 0.43 | — | — |
| Part A:Part B | 2:1 | 0.9:1 | 0.92:1 | 0.98:1 | 1:1 | 2.26:1 | 2.26:1 |
| (wt:wt) | | | | | | | |
| total wt % filler | 78.6 | 80.4 | 80.3 | 80.2 | 80.1 | 81.0 | 81.0 |

TABLE 3
Composition of Examples Utilizing Alumina Fillers

| | Ex. 9 | Ex. 10 | Ex. 11 | Ex. 12 | Ex. 13 |
|---|---|---|---|---|---|
| | wt % | wt % | wt % | wt % | wt % |
| Part A | | | | | |
| Polyamide 2 | 16.1 | 16.1 | 15.4 | 14.6 | 12.1 |
| Polyamide 3 | 3.8 | 3.8 | 3.7 | 3.5 | 2.9 |
| Amine 1 | 3.8 | 3.8 | 3.7 | 3.5 | 2.9 |
| Filler 3 | 75.1 | 52.6 | 53.3 | 54.2 | 56.8 |
| Filler 4 | — | 22.5 | 22.8 | 23.2 | 24.4 |
| Dispersant 1 | 0.38 | 0.38 | 0.38 | 0.43 | 0.41 |
| Accelerator3 | 0.76 | 0.76 | 0.73 | 0.69 | 0.57 |
| Part B | | | | | |
| Epoxy 1 | 5.0 | 5.0 | 4.7 | 4.5 | 3.7 |
| Acrylate 1 | 9.5 | 9.5 | 9.0 | 8.5 | 7.0 |
| Filler 3 | 85.1 | 59.6 | 60.1 | 60.6 | 62.2 |
| Filler 4 | — | 25.5 | 25.8 | 26.0 | 26.6 |
| Dispersant 1 | 0.43 | 0.43 | 0.43 | 0.43 | 0.44 |
| Part A:Part B | 1:1 | 1:1 | 1:1 | 1:1 | 1:1 |
| (wt:wt) | | | | | |
| total wt % filler | 80.1 | 80.1 | 81.0 | 82.0 | 85.0 |

TABLE 4
Composition of Examples
Utilizing ATH Fillers

| | Ex. 14 | Ex. 15 | Ex. 16 | Ex. 17 |
|---|---|---|---|---|
| | wt % | wt % | wt % | wt % |
| Part A | | | | |
| Polyamide 2 | 14.84 | 15.25 | 14.84 | 15.24 |
| Polyamide 3 | 3.52 | 3.62 | 3.52 | 3.62 |
| Amine 1 | — | 3.62 | — | 3.62 |
| Amine 4 | 4.13 | — | 4.13 | — |
| Filler 1 | 75.29 | 75.29 | 75.29 | 75.25 |
| Dispersant 1 | 1.51 | 1.51 | 1.51 | 1.5 |
| Accelerator 2 | 0.71 | 0.72 | — | — |
| Accelerator 3 | — | — | 0.71 | 0.77 |
| Part B | | | | |
| Epoxy 1 | 4.59 | 4.59 | 4.59 | 8.16 |
| Acrylate 1 | 8.68 | 8.68 | 8.68 | 5.11 |
| Filler 1 | 85.03 | 85.03 | 85.03 | 85.03 |
| Dispersant 1 | 1.7 | 1.7 | 1.7 | 1.7 |
| Part A:Part B | 1:1 | 0.98:1 | 1:1 | 0.83:1 |
| (wt:wt) | | | | |
| Total wt % filler | 80.1 | 80.2 | 80.1 | 81 |

### Synthesis of Liquid Polyamide (Polyamide 1 and Polyamide 2)

A list of reagents used in the synthesis of Polyamides 1 and 2 is provided in Table 5 and the synthesis formulation and conditions are summarized in Table 6.

TABLE 5
Materials used for synthesis of Liquid Polyamides

| | Material | Description | Supplier | Location |
|---|---|---|---|---|
| Diacid | PRIPOL 1013 | Dimer acid, long chain | Croda | Delaware, US |
| | | diacid (Eq. Wt 287.7) | | |
| Diamine 1 | Ethylenediamine | ≥99% | Alfa Aesar | Haverhill, MA, |
| | | | | US |
| Diamine 2 | Piperazine | 99% | Sigma Aldrich | St. Louis, MO, |
| | | | | US |
| Catalyst | Phosphoric Acid | 85% Phosphoric Acid | J.T. Baker | Center Valley, |
| | | | | PA, US |

TABLE 6
Formulation for synthesis of Polyamides 1 and 2

| | | | | Diamine | | Catalyst |
|---|---|---|---|---|---|---|
| | Synthesis | | Diacid | Ethylene | | 85% Phosphoric |
| | Temp | Vacuum | Pripol 1013 | diamine | Piperazine | Acid |
| Polyamide 1 | 225° C. | Full vacuum | 100 mol % | 5 mol % | 95 mol % | 300 ppm |
| Polyamide 2 | 200° C. | No vacuum | 100 mol % | 5 mol % | 95 mol % | 300 ppm |

The synthesis of liquid polyamides was conducted in a 1 L reactor. Isopropanol (IPA) was used to clean the kettle before charging the raw material followed by drying the chamber with heat under vacuum. The target batch temperature was set to 150° C. Once the batch temperature reached 150° C., the batch temperature set-point was increased to 177˜182° C. to let the vapor reach overhead. When the vapor reached the overhead, the overhead temperature gradually increased to 100° C. Approximately 80˜90% of the theoretical amount of water was collected from the distillation. For Polyamide 1, after the overhead temperature decreased, and after another 5 minutes, the target batch temperature was set to 225° C. The overhead temperature gradually increased and then decreased again. after 5 minutes, full vacuum (1˜2 torr) was pulled in the chamber. The torque gradually increased and levelled off. When the torque levelled, the chamber was vented to atmosphere pressure. About 10 lbs of resin was drained into an aluminum pan covered with release liner. For Polyamide 2, after the overhead temperature decreased, and after another 5 minutes, the target batch temperature was set to 200° C., and was stirring for 1.5 hours. About 10 lbs of resin was drained into an aluminum pan covered with release liner.

Polyamide 1 was synthesized using a diamine and a diacid with a mole ratio of 2.5 to 1. This yielded an equivalent molecular weight of 637.0 g/eq, where the chain was terminated with amine. The equivalent molecular weight is converted by amine number, which is measured by titration method. About 4 grams of sample were dissolved in 100 mL toluene and 50 mL IPA mixture, followed by titration with 0.1N TBAOH in methanol for Acid Content or 0.15N HCl in IPA for Amine Content. Polyamide 2 was synthesized using a diamine and a diacid with a mole ratio of 1.7 to 1. This yielded an equivalent molecular weight of 555.6 g/eq, where the chain was terminated with amine. The amine end-groups of both Polyamide 1 and Polyamide 2 were comprised of 95 mol % secondary amine and 5 mol % primary amine.

TABLE 7
Properties of Polyamides 1 and 2

| | | Equivalent | Viscosity @ 25° C. |
|---|---|---|---|
| | Diamide: | Mn | and |
| | Diacid mole ratio | (g/eq) | 100 rad/sec (Poise) |
| Polyamide 1 | 2.5 | 637 | 1666 |
| Polyamide 2 | 1.7 | 555.6 | 2332 |

### Surface Treatment of Filler 5 and Filler 6

Silane-functionalized ATH filler was prepared by reacting the ATH surface with silanes under acidic conditions. A 2 L capacity 3-neck flask was equipped with a stir rod and paddle powered by an air motor. 150 mL ethanol, 50 mL H₂O and 100 g ATH particles (KH-17R, available from KC Corp, Korea) were added to the flask with stirring. The pH of the solution was adjusted to approximately 4.5 using acetic acid (˜1.5 mL) and 1 gram of silane was added dropwise. Two silanes were used: SILQUEST A-1230 (Momentive Performance Materials, Waterford, N.Y., US) was used to treat Filler 6 and phenyltrimethoxysilane (Sigma-Aldrich Corporation, Saint Louis, Mo., US) was used for Filler 5. The temperature of the solution was adjusted to 65° C. and held for 12 hours. The resulting product was then filtered through a Buchner funnel and rinsed three times with ethanol to remove any excess silane. The filtered product was then dried for 2 hours at 120° C.

### Test Procedures

### Rheology of Parts A and B

Viscosity was measured using a parallel-plate geometry at 1% strain on a ARES Rheometer (TA Instruments, Wood Dale, Ill., US) equipped with a forced convection oven accessory, at angular frequencies ranging from 10-500 rad/s at 25° C.

### Overlap Shear Adhesion (OLS)

Two 0.5 inch (1.27 cm) wide×4 inch (10 cm) long×0.125 inch (0.32 cm) thick aluminum coupons were cleaned using methyl ethyl ketone (MEK) and otherwise left untreated. At the tip of one coupon, a 0.5 inch by 0.5 inch (1.27 cm×1.27 cm) square was covered by the mixed polyamide/epoxy paste and then laminated with another coupon in the opposite tip direction to give about 10-30 mils (0.25-0.76 mm) of paste between the aluminum coupons. The laminated aluminum coupons were then cured at one of the following sets of conditions: room temperature for 24 hours, room temperature for 15 hours, 100° C. for 1 hour, or 120° C. for 1 hour to give complete curing. The sample was then conditioned at room temperature for 30 min prior to overlap shear testing.

OLS tests were conducted on an Instron Universal Testing Machine model 1122 (Instron Corporation, Norwood, Mass., US) according to the procedures of ASTM D1002-01, “Standard Test Method for Apparent Shear Strength of Single-Lap-Joint Adhesively Bonded Metal Specimens by Tension Loading (Metal-to-Metal).” The crosshead speed was 0.05 inch/min.

### Tensile Properties

For tensile tests, dogbone-shaped samples were made by pressing the mixed paste into a dogbone-shaped silicone rubber mold, which was then laminated with release liner on both sides. The dogbone shape gives a sample with a length of about 0.6 inch in the center straight area, a width of about 0.2 inch in the narrowest area, and a thickness of about 0.06˜0.1 inch. Samples were then cured at room temperature for 24 hours, room temperature for 15 hours, 100° C. for 1 hour, or 120° C. for 1 hour to be fully cured prior to tensile testing.

Tensile tests were conducted on an Instron Universal Testing Machine model 1122 (Instron Corporation, Norwood, Mass., US) according to ASTM D638-03, “Standard Test Method for Tensile Properties of Plastics.” The crosshead speed was 0.05 inch/min.

### Thermal Conductivity

For thermal conductivity measurements, disk-shaped samples were made by pressing the mixed paste into a disk-shaped silicone rubber mold which was then laminated with release liner on both sides. The disk shape gives samples with a diameter of 12.6 mm and a thickness of 2.2 mm. The sample was then cured at room temperature for 24 hours, room temperature for 15 hours, or 100° C. for 1 hour to give complete curing.

Specific heat capacity, cₚ, was measured using a Q2000 Differential Scanning calorimeter (TA Instruments, Eden Prairie, Minn., US) with sapphire as a method standard.

Sample density was determined using a geometric method. The weight (m) of a disk-shaped sample was measured using a standard laboratory balance, the diameter (d) of the disk was measured using calipers, and the thickness (h) of the disk was measured using a Mitatoyo micrometer. The density, p, was calculated by ρ=m/(π·h·(d/2)²).

Thermal diffusivity, α(T), was measured using an LFA 467 HYPERFLASH Light Flash Apparatus (Netzsch Instruments, Burlington, Mass., US) according to ASTM E1461-13, “Standard Test Method for Thermal Diffusivity by the Flash Method.”

Thermal conductivity, k, was calculated from thermal diffusivity, heat capacity, and density measurements according the formula:

k=α·Cₚ·ρ

where k is the thermal conductivity in W/(m K), α is the thermal diffusivity in mm²/s, Cₚ is the specific heat capacity in J/K-g, and ρ is the density in g/cm³.

### Flame Retardancy

For flame retardancy tests, strip samples were made by pressing the mixed uncured paste into strip-shaped silicone rubber molds, and were then laminated with release liner on both sides. The resulting samples had a length of about 5 inch (12.7 cm), a width of 0.5 inch (1.27 cm), and a thickness of 0.06 inch (1.52 mm). Samples were then cured at room temperature for 25 hours, room temperature for 24 hours, 100° C. for 1 hour, or 120° C. for 1 hour to be fully cured prior to flame retardancy testing. Both horizontal and vertical testing configurations were conducted using a burner with methane gas, in accordance with the procedures outlined in UL94 “Tests for Flammability of Plastic Materials for Parts in Devices and Appliances.”

### Dielectric Breakdown Strength

Dielectric breakdown strength measurements were performed according to ASTM D149-09(2013), “Standard Test Method for Dielectric Breakdown Voltage and Dielectric Strength of Solid Electrical Insulating Materials at Commercial Power Frequencies” using a Phenix Technologies Model 6TC4100-10/50-2/D149 (available from Phenix Technologies, Accident, MD, US) that is specifically designed for testing DC breakdown from 3-100 kV and AC breakdown in the 1-50 kV, 60 Hz range. Each measurement was performed while the sample was immersed in the fluid indicated. The average breakdown strength was based on an average of measurements up to 10 or more samples. As is typical, a frequency of 60 Hz and a ramp rate of 500 volts per second was utilized for these tests.

### Electrical Volume Resistivity

Electrical surface resistance and volume resistivity was measured with a Keithley Model 6517 A electrometer (Tektronix, Beaverton, Oreg., US) with 100 femtoAmp resolution and an applied voltage of 500 Volts, according to the procedures in to ASTM D257-14, “Standard Test Methods for DC Resistance or Conductance of Insulating Materials.” A Keithley Model 8009 Resistivity test fixture was used with compressible conductive rubber electrodes and 1 lb electrode force over approximately 2.5 inches of electrode and sample. The samples were approximately 18 mils thick. The corresponding detection threshold for surface resistivity is approximately 10¹⁷ ohms. Each sample was measured once, and an electrification time of 60 seconds was employed. A high resistance sample PTFE, a low resistance sample (bulk loaded carbon in kapton), and a moderate resistance sample (paper) were used as material reference standards. detailed description of test method requirements refer documentation.

### Results

### Green Strength Build-up

Table 8 shows the results of OLS strength on bare aluminum substrate after 10 min at room temperature (RT). All of the materials in Table 8 included two types of polyamide: Polyamide 3 combined with either Polyamide 1 or Polyamide 2. After 10 min at RT, no overlap shear strength was observed for Comparative Example CE1, and the OLS strength Example 14 was only 0.054 MPa. Example 15, which included a short aliphatic diamine, demonstrated slightly higher improved OLS green strength of 0.2 MPa after 10 min at ambient temperature. Using calcium triflate as the catalyst, Example 3 demonstrates 0.50 MPa OLS green strength after 10 min at room temperature. A comparison between Example 17 and Example 3 shows an improvement in OLS strength at room temperature for 10 min from 0.04 MPa to 0.5 MPa by increasing the TMPAT amount.

TABLE 8
Green Strength Build-up:
Overlap Shear Strength after
10 Minutes at Ambient
Temperature

| Example | OLS (MPa) on Aluminum |
|---|---|
| CE1 | Not Observable |
| Ex. 14 | 0.054 |
| Ex. 15 | 0.2 |
| Ex. 16 | 0.02 |
| Ex. 17 | 0.04 |
| Ex. 1 | 0.23 |
| Ex. 2 | 0.37 |
| Ex. 3 | 0.50 |

Mechanical and Adhesion Performance after Curing

Table 9 shows the mechanical and adhesion performance after further curing at ambient temperature (RT) for 10 minutes and 24 hours and at 120° C. for 1 hour. Both Examples 3 and 4 show increased adhesion after longer cure times at room temperature and after curing at 120° C. for 1 hour.

TABLE 9
Viscosity, Adhesion, and Mechanical Performance

| | | Ex. 3 | Ex. 4 |
|---|---|---|---|
| | Viscosity (Poise) | 1508 (Part A); | 1513 (Part A); |
| | 10.0 rad/sec, 25° C. | 656 (Part B) | 370 (Part B) |
| OLS on Aluminum | RT for 10 min | 0.50 | 0.86 |
| (MPa) | RT for 24 hrs | 4.5 | 6.3 |
| | 120° C. for 1 hr | 6.1 | 10.9 |
| Tensile Strength | RT for 24 hrs | 3.3 | 3.7 |
| (MPa) | 120° C. for 1 hr | 4.7 | 8.6 |
| Elongation at | RT for 24 hrs | 8.1 | 7.8 |
| break (%) | 120° C. for 1 hr | 13.3 | 11.2 |
| Modulus | RT for 24 hrs | 75.0 | 82.3 |
| (MPa) | 120° C. for 1 hr | 71.9 | 115.6 |

Table 10 compares the mechanical and adhesion performance of compositions prepared using untreated and treated ATH filler. All compositions in Table 10 were allowed to cure at 120° C. for 1 hour. Example 7 included ATH which was surface-treated with phenyl-trimethoxysilane; Example 8 included ATH which was surface-treated with a silane containing an oligomeric non-reactive PEG chain; and the ATH used in Example 3 was not surface treated. Examples 7 and 8 demonstrate higher tensile strength and modulus and a decreased elongation at break in comparison to Example 3.

TABLE 10
Effect of ATH Surface
Modification on Performance

| | Ex. 3 | Ex. 7 | Ex. 8 |
|---|---|---|---|
| OLS (MPa) | 6.1 | 13.8 | 9.4 |
| Tensile strength | 4.7 | 9.3 | 9.6 |
| (MPa) | | | |
| Modulus (Mpa) | 71.9 | 161 | 142 |
| Elongation at break | 13.3 | 7.8 | 9.7 |
| (%) | | | |

Table 11 summarizes properties of compositions prepared using alumina filler. Example 9 contains only semi-spherical alumina, TM1250, whereas Examples 10-12 use a combination of TM1250 and spherical alumina, BAK 40. As the overall filler loading was increased from 80.1 wt % to 82.0%, OLS strength and tensile strength increased and the elongation at break decreased.

TABLE 11
Performance of Compositions
Comporising Alumina Fillers

| | | Ex. 9 | Ex. 10 | Ex. 11 | Ex. 12 |
|---|---|---|---|---|---|
| OLS on | RT for 10 min | 0.47 | 0.55 | 0.68 | 0.77 |
| Alumina | RT for 24 hr | 5.8 | 6.9 | 6.9 | 8.3 |
| (MPa) | 120° C. for 1 hr | 10.1 | 12.7 | 16.4 | 17.4 |
| Tensile | RT for 24 hrs | 6.4 | 5.1 | 5.8 | 5.9 |
| Strength | 120° C. for 1 hr | 5.5 | 6.8 | 9.8 | 9.8 |
| (MPa) | | | | | |
| Elongation | RT for 24 hrs | 16.5 | 22.1 | 20.6 | 16.5 |
| at break | 120° C. for 1 hr | 26 | 19.5 | 20.8 | 16.1 |
| (%) | | | | | |
| Modulus | RT for 24 hrs | 58.1 | 45 | 49.5 | 56.6 |
| (MPa) | 120° C. for 1 hr | 28.4 | 47.2 | 58.7 | 75.1 |

### Other Physical Properties: Thermal Conductivity, Flame Retardancy, Dielectric Strength, and Insulation Resistance.

Table 12 summarizes the thermal properties and flammability rating, of fully cured samples. Example 4 had a higher filler content than Example 9 and also demonstrated a higher thermal conductivity. Example 10, which comprised a combination of filler types, demonstrated a higher thermal conductivity than Example 9, which included only one type of filler at the same level as Example 10. Examples 10 through 13, which contained increasing amounts of filler, also demonstrated increasing amounts of thermal conductivity.

TABLE 12
Thermal conductivity of fully cured compositions

| | Ex. 4 | Ex. 9 | Ex. 10 | Ex. 11 | Ex. 12 | Ex. 13 |
|---|---|---|---|---|---|---|
| Thermal | 0.71 | 0.47 | 0.53 | 0.52 | 0.57 | 0.72 |
| diffusivity | | | | | | |
| (mm²/s) | | | | | | |
| Density (g/ml) | 1.82 | 2.50 | 2.45 | 2.49 | 2.62 | 2.74 |
| Heat capacity | 1.29 | 1.01 | 1.02 | 1.11 | 1.11 | 1.02 |
| (J/K/g) | | | | | | |
| Thermal | 1.66 | 1.18 | 1.33 | 1.44 | 1.65 | 2.03 |
| conductivity | | | | | | |
| W/(mK) | | | | | | |
| UL94 | V0 | n/a | HB | n/a | n/a | n/a |
| Classification | | | | | | |

The electrical performance test results for Example 10 were as follows: dielectric breakdown strength=19.1 kV/mm, electrical volume insulation resistance=9×10¹⁰ Ohm.

Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows. All references cited in this disclosure are herein incorporated by reference in their entirety.

1. A curable composition comprising:
a polyamide composition comprising a first polyamide, the first polyamide comprising a tertiary amide in the backbone thereof and being amine terminated;
an amino functional compound comprising from 2 to 20 carbon atoms;
a multifunctional (meth)acrylate;
an epoxy resin; and
an inorganic filler, the inorganic filler being present an amount of at least 25 wt. %, based on the total weight of the curable composition.

2. The curable composition of claim 1, wherein the polyamide composition is present in the curable composition in an amount of between 1 and 50 wt. %, based on the total weight of the curable composition.

3. The curable composition of claim 1, wherein the amino functional compound is present in the curable composition in an amount of between 0.2 and 30 wt. %, based on the total weight of the curable composition.

4. The curable composition of claim 1, wherein the multifunctional (meth)acrylate is present in the curable composition in an amount of between 2 and 50 wt. %, based on the total weight of the curable composition.

5. The curable composition of claim 1, wherein the epoxy resin is present in the curable composition in an amount of between 0.2 and 50 wt. %, based on the total weight of the curable composition.

6. The curable composition of claim 1, wherein tertiary amides are present in the first polyamide in an amount of at least 50 mol. %, based on the total amide content present in the backbone of the first polyamide.

7. The curable composition of claim 1, wherein the first polyamide component comprises the reaction product of (i) a diacid; and (ii) a diamine, wherein the diamine comprises a secondary diamine or a secondary/primary hybrid diamine;

8. The curable composition of claim 1, the polyamide composition further comprising a second polyamide, wherein the second polyamide comprises a multifunctional polyamidoamine.

9. The curable composition of claim 1, wherein the first polyamide component is present in the polyamide composition in an amount of at least 50 wt. %, based on the total weight of polyamide in the polyamide composition.

10. The curable composition of claim 1, further comprising a catalyst comprising a Lewis acid.

11. (canceled)

12. (canceled)

13. The curable composition of claim 1, wherein the curable composition provides, upon curing, a tensile strength of 0.5 to 16 N/mm2.

14. The curable composition of claim 1, wherein the curable composition provides, upon curing, an elongation at break of greater than 6%.

15-19. (canceled)

20. The curable composition of claim 1, wherein the curable composition provides, upon curing, a thermal conductivity of 0.5-2 W/(mK)

21. The curable composition of claim 1, wherein the curable composition provides, upon curing, a flame retardancy of at least UL94-HB.

22. The curable composition of claim 1, wherein the curable composition provides, upon curing, the dielectric breakdown strength of greater than 5 kV/mm and electrical volume insulation resistance of at least 1×10⁹ Ohm cm.

23. The curable composition of claim 1, further comprising a dispersant comprising a binding group and a compatibilizing segment.

24. The curable composition of claim 1, wherein the amino functional compound comprises a diamine.

25. An article comprising a cured composition, wherein the cured composition is the reaction product of the curable composition according to claim 1.

26. (canceled)

27. (canceled)

28. The article of claim 1, wherein the substrate is a metal substrate.

29. (canceled)

30. A battery module comprising a plurality of battery cells connected to a first base plate by a first layer of a curable composition according to claim 1.

31. (canceled)
